(19) United States
(12) Patent Application Publication
(10) Pub. No.: US 2019/0225835 A1
(43) Pub. Date: Jul. 25, 2019

(54) POLYPHENOL ALKOXYLATE CONTAINING BLENDS AND COATINGS

(71) Applicant: RESINATE MATERIALS GROUP, INC., Plymouth, MI (US)

(72) Inventors: Gary E. Spilman, Northville, IL (US); Michael R. Christy, Howell, MI (US); Rick Tabor, Plymouth, MI (US); Brian T. Comstock-Reid, Ypsilanti, MI (US); Jack R. Kovsky, Detroit, MI (US); Michelle Marie Samson, Allen Park, MI (US)

(21) Appl. No.: 16/332,014

(22) PCT Filed: Sep. 12, 2017
(86) PCT No.: PCT/US17/51197

§ 371 Date: Mar. 11, 2019

Related U.S. Application Data
(60) Provisional application No. 62/393,559, filed on Sep. 12, 2016.
(60) Provisional application No. 62/393,561, filed on Sep. 12, 2016.
(60) Provisional application No. 62/438,135, filed on Dec. 22, 2016.

(51) Int. Cl. C09D 175/10; C08G 18/42; C08G 18/54; C08G 18/36; C08G 18/40; C08G 18/65; C08G 18/75

(52) U.S. Cl. CPC C09D 175/10; C08G 18/4213; C08G 18/546; C08G 18/755; C08G 18/4027; C08G 18/6547; C08G 18/36

(57) ABSTRACT

The present invention relates to polyol blends containing a polyol and a polyphenol alkoxylate, i.e. an alkoxylated polyphenol, and coatings prepared from these blends. The polyol blends have the advantage of a low residual polyphenol content and have desirable viscosity characteristics without the need for diluents or solvents which could result in unwanted VOC emissions. In another aspect of the invention, polyester polyols are prepared using polyphenol alkoxyiates. Coatings prepared using these polyol compositions have improved salt spray corrosion resistance, along with a variety of other excellent coating performance properties. Also, the polyols used herein can contain a significant recycle and biorenewable content, making these blends and coatings sustainable alternatives to petroleum based polyol products.

### FIELD OF THE INVENTION

The present invention relates to polyol blends containing a polyol and a polyphenol alkoxylate, i.e. an alkoxylated polyphenol, and coatings prepared from these blends. The polyol blends have the advantage of a low residual polyphenol content and have desirable viscosity characteristics without the need for diluents or solvents which could result in unwanted VOC (volatile organic compound) emissions. In another aspect of the invention, polyester polyols are prepared using polyphenol alkoxylates. Coatings prepared using these polyol compositions have improved salt spray corrosion resistance, along with a variety of other excellent coating performance properties. Also, the polyols used herein can contain a significant recycle and biorenewable content, making these blends and coatings sustainable alternatives to petroleum based polyol products.

### BACKGROUND OF THE INVENTION

Polyester polyols are commonly used intermediates for the manufacture of a wide variety of products such as polyurethane products, for example flexible and rigid foams, polyisocyanurate foams, coatings, powder coatings, sealants, adhesives, and elastomers. An area of significant commercial importance is the production of high performance coatings. As will become apparent from this invention, it was recognized that alkoxylated polyphenols, particularly propoxylated bisphenol-A, can be used to provide polyol blends that are particularly useful for preparing such high performance coatings.

A coating is a covering that is applied to the surface of a substrate. Coatings can be decorative, functional, or both. An example of a decorative coating would be an artist's paint. An example of a functional coating would be an adhesive. An example of a coating with both a decorative and a functional purpose would be an exterior house paint which both protects the exterior surface of the house and is aesthetically appealing.

Coatings are used in many applications, including paper, packaging, films, printing, construction products, automobiles, aircraft, marine products, and all sorts of other manufactured products. Furthermore, functional coatings can be applied to change the surface properties of the substrate, such as adhesion, wetability, corrosion resistance, or wear resistance. Aside from the decorative aspects, an important function of coatings is to protect the substrate from the environment and wear and tear under usage conditions.

Polyester containing coatings such as polyethylene terephthalate (PET) coatings are commercially important. These coatings have been used in various forms for protective and barrier coatings, and other types of packaging, as well as for making substrates themselves. However, there are challenges in developing coatings based on these polyols while also achieving robust performance characteristics, such as resistance to corrosion, such as salt-spray corrosion, and abrasion. Also, as companies increasingly seek to offer products with improved sustainability, the availability of intermediates produced from bio-renewable and/or recycled materials becomes an important consideration. Thus, there remains a need for these ecologically-friendly or “green” products to deliver equal or better performance than their traditional petroleum-based alternatives, yet at a comparable price point.

Polyphenol derived polymers such as poly(bisphenol-A carbonate) have a wide variety of applications and have been used for making bottles, transparent panels, and coatings. However, a potential disadvantage of poly(bisphenol-A carbonate) is the presence of the residual polyphenol, bisphenol-A (BPA) or the liberation of the bisphenol-A from the manufactured polymer or product. There are some safety concerns with the presence of some polyphenols, such as bisphenol-A, in products that contact food products or that are intended for contact with humans and animals. Thus, there is a need to eliminate residual polyphenols, such as bisphenol-A, or sources that can liberate the polyphenol from many consumer products.

It has been found in the blends and coatings of the present invention that poly(bisphenol-A carbonate) can be replaced with an alkoxylated polyphenol such as a propoxylated bisphenol-A. Such coatings containing alkoxylated polyphenols are found to be less prone to liberating the polyphenol and would provide a potential safety advantage. Surprisingly, these alkoxylated polyphenols provide improved corrosion resistance for metal coatings. Furthermore, the addition of alkoxylated polyphenols has been surprisingly found to provide low viscosity polyol blends. This low viscosity is an important advantage, because such blends can be achieved without the need for viscosity-reducing solvents, which can have the disadvantage of resulting in unwanted VOC emissions.

It has therefore been found in the present invention that alkoxylated polyphenols can be used to prepare blends and coatings having desirable performance characteristics.

### SUMMARY OF THE INVENTION

The present invention relates to polyol blends containing a polyol and a polyphenol alkoxylate, i.e. an alkoxylated polyphenol, and coatings prepared from these blends. The polyol blends have the advantage of a low residual polyphenol content and have desirable viscosity characteristics without the need for diluents or solvents which could result in unwanted VOC emissions. In another aspect of the invention, polyester polyols are prepared using polyphenol alkoxylates. Coatings prepared using these polyol compositions have improved salt spray corrosion resistance, along with a variety of other excellent coating performance properties. Also, the polyols used herein can contain a significant recycle and biorenewable content, making these blends and coatings sustainable alternatives to petroleum based polyol products.

### DETAILED DESCRIPTION OF THE INVENTION

The present invention relates to a polyol blend comprising:

(a) a polyol selected from a polyester polyol, a polycaprolactone polyester polyol, a poly(hydroxyl alkyl carboxylic acid) polyester polyol, a polyether polyol, a polycarbonate polyol, a polyester/carbonate polyol, a polyether/ester polyol, an acrylic polyol, poly(1,3-propanediol), poly(1,4-butanediol), an oleochemical polyol, polyaspartic esters, polytetrahydrofurans (i.e. a polytetrahydrofuran polyol), and combinations thereof; and

(b) a polyphenol alkoxylate.

In another aspect the present invention relates to a polyol blend comprising:

(a) a polyol selected from a polyester polyol, a polycaprolactone polyester polyol, a poly(hydroxyl alkyl carboxylic acid) polyester polyol, a polyether polyol, a polycarbonate polyol, a polyester/carbonate polyol, a polyether/ester polyol, an acrylic polyol, poly(1,3-propanediol), poly(1,4-butanediol), an oleochemical polyol, polyaspartic esters, polytetrahydrofurans (i.e. a polytetrahydrofuran polyol), and combinations thereof; and

(b) a polyphenol alkoxylate or a ring opened polyglycidyl ether.

In another aspect the present invention relates to a polyol blend comprising:

(a) a polyol selected from a polyester polyol, a polycaprolactone polyester polyol, a poly(hydroxyl alkyl carboxylic acid) polyester polyol, a polyether polyol, a polycarbonate polyol, a polyester/carbonate polyol, a polyether/ester polyol, an acrylic polyol, an oleochemical polyol, polyaspartic esters, and combinations thereof; and

(b) a polyphenol alkoxylate.

In another aspect the present invention relates to a polyol blend comprising:

(a) a polyol selected from a polyester polyol, a polycaprolactone polyester polyol, a poly(hydroxyl alkyl carboxylic acid) polyester polyol, a polyether polyol, a polycarbonate polyol, a polyester/carbonate polyol, a polyether/ester polyol, an acrylic polyol, an oleochemical polyol, polyaspartic esters, and combinations thereof; and

(b) a polyphenol alkoxylate or a ring opened polyglycidyl ether.

In another aspect the present invention relates to a polyol blend comprising from about 5% to about 95% by weight of the polyol and from about 95% to about 5% by weight of the polyphenol alkoxylate or the ring opened polyglycidyl ether.

In another aspect the present invention relates to a polyol blend comprising from about 10% to about 90% by weight of the polyol and from about 90% to about 10% by weight of the polyphenol alkoxylate or the ring opened polyglycidyl ether.

In another aspect the present invention relates to a polyol blend wherein the polyether polyol comprises a poly(1,2-butylene oxide) polyol; a polyether polyol comprising copolymers of 1,2-butylene oxide with 1,2-propylene oxide, ethylene oxide or mixtures of 1,2-propylene oxide with ethylene oxide; or mixtures thereof.

In another aspect the present invention relates to a polyol blend wherein the polyether polyol has a water solubility at 23° C. of less than about 7.5% by weight.

In another aspect the present invention relates to a polyol blend wherein the polyether polyol has a water solubility at 23° C. of less than about 5.0% by weight.

In another aspect the present invention relates to a polyol blend wherein the polyether polyol has a water solubility at 23° C. of less than about 2.5% by weight.

In another aspect the present invention relates to a polyol blend wherein the polyether polyol has a water solubility at 23° C. of less than about 2.0% by weight.

In another aspect the present invention relates to a polyol blend wherein the polyether polyol has a water solubility at 23° C. of less than about 1.5% by weight.

In another aspect the present invention relates to a polyol blend wherein the polyol is selected from a polyester polyol, a polytetrahydrofuran polyol, a poly-(1,3,-propanediol) polyol, a polyester/carbonate polyol, a polyether/ester polyol, an oleochemical polyol, and combinations thereof.

In another aspect, the present invention relates to a polyol blend wherein the polyphenol alkoxylate is selected from a bisphenol alkoxylate, a triphenol alkoxylate, and combinations thereof.

In another aspect, the present invention relates to a polyol blend wherein the polyphenol alkoxylate is selected from a bisphenol alkoxylate.

In another aspect, the present invention relates to a polyol blend wherein the polyphenol alkoxylate is selected from a triphenol alkoxylate.

In another aspect, the present invention relates to a polyol blend wherein the polyphenol alkoxylate is selected from a non-halogenated bisphenol alkoxylate or a non-halogenated triphenol alkoxylate.

In another aspect, the present invention relates to a polyol blend that is substantially free of halogenated bisphenol alkoxylates or halogenated triphenol alkoxylates.

In another aspect, the present invention relates to a polyol blend wherein the polyol is selected from a polyester polyol, a polycarbonate polyol, a polyester/carbonate polyol, an oleochemical polyol, and combinations thereof.

In another aspect, the present invention relates to a polyol blend wherein the polyol is a polyester polyol.

In another aspect, the present invention relates to a polyol blend wherein the polyester polyol is selected from an aromatic polyester polyol, an aliphatic polyester polyol, and combinations thereof.

In another aspect, the present invention relates to a polyol blend wherein the polyester polyol is an aromatic polyester polyol.

In another aspect, the present invention relates to a polyol blend wherein the polyester polyol is an aliphatic polyester polyol.

In another aspect, the present invention relates to a polyol blend that is substantially free of an aliphatic polyester polyol blend component.

In another aspect, the present invention relates to a polyol blend wherein the aromatic polyester polyol is derived from an aromatic thermoplastic polyester.

In another aspect, the present invention relates to a polyol blend wherein the non-halogenated polyphenol alkoxylate is a non-halogenated bisphenol alkoxylate.

In another aspect, the present invention relates to a polyol blend wherein the bisphenol-A alkoxylate is selected from bisphenol-A ethoxylates, bisphenol-A propoxylates, and bisphenol-A mixed ethoxylates/propoxylates.

In another aspect, the present invention relates to a polyol blend wherein the bisphenol-A alkoxylate is a bisphenol-A propoxylate.

In another aspect, the present invention relates to a polyol blend wherein the bisphenol-A alkoxylate is a propoxylated adduct of bisphenol-A comprising between 1 and 4 propylene oxide groups per phenolic hydroxyl group.

In another aspect, the present invention relates to a polyol blend having a viscosity less than about 15,000 cP at 25° C.

In another aspect, the present invention relates to a polyol blend having a viscosity less than about 12,500 cP at 25° C.

In another aspect, the present invention relates to a polyol blend having a viscosity less than about 10,000 cP at 25° C.

In another aspect, the present invention relates to a polyol blend further comprising less than 30% by weight of a green solvent selected from: butyl acetate, methoxypropyl acetate, t-butyl acetate, dimethyl carbonate, isopropyl acetate, ethyl lactate, amyl acetate, isobutyl acetate, ethyl acetate, cyclopentyl methyl ether, 2-methyl tetrahydrofuran and mixtures thereof. The green solvent can be derived from renewable resources or recycled materials.

In another aspect, the present invention relates to a polyol blend that is substantially free of bisphenol-A.

In another aspect, the present invention relates to a polyol blend having a free bisphenol-A content of less than about 1000 ppm by weight of the polyol blend.

In another aspect, the present invention relates to a polyol blend having a free bisphenol-A content of less than about 250 ppm by weight of the polyol blend.

In another aspect, the present invention relates to a polyol blend having a low VOC emission such that the VOC content is less than about 250 g/L.

In another aspect, the present invention relates to a polyol blend wherein the VOC content is less than about 100 g/L.

In another aspect, the present invention relates to a polyol blend wherein the VOC content is less than about 50 g/L.

In another aspect, the present invention relates to a polyol blend wherein the non-halogenated polyphenol alkoxylate is a non-halogenated triphenol alkoxylate.

In another aspect, the present invention relates to a polyol blend wherein the thermoplastic polyester is a copolymer of an aromatic polyacid and a glycol, wherein
(a) the aromatic polyacid is selected from phthalic acid, terephthalic acid, 2,5-furandicarboxylic acid, isophthalic acid, dihydroferulic acid, salts thereof, C1-C6 monoesters thereof, C1-C6 diesters thereof, and combinations thereof; and
(b) the glycol is selected from ethylene glycol, 1,2-propanediol, 1,3-propanediol, 1,2-butanediol, 1,3-butanediol, 1,4-butanediol, 2,3-butanediol, neopentyl glycol, glycerol, trimethylolpropane, 3-methyl-1,5-pentanediol, 1,3-cyclohexane diol, 1,4-cyclohexane diol, 1,3-cyclohexanedimethanol, 1,4-cyclohexanedimethanol, diethylene glycol, tetraethylene glycol, dipropylene glycol, triethylene glycol, tripropylene glycol, polyethylene glycol, polypropylene glycol, 2,2,4,4-tetramethyl-1,3-cyclobutane diol, and block or random copolymer glycols of ethylene oxide and propylene oxide, and combinations thereof.

In another aspect, the present invention relates to a polyol blend that is substantially free of isophthalic acid and dimethyl isophthalate.

In another aspect the present invention relates to a polyol blend wherein the thermoplastic polyester is selected from polyethylene terephthalate (PET), polybutylene terephthalate (PBT), polytrimethylene terephthalate (PTT), glycol-modified polyethylene terephthalate (PETG), copolymers of terephthalic acid and 1,4-cyclohexanedimethanol, isophthalic acid-modified copolymers of terephthalic acid and 1,4-cyclohexanedimethanol, copolymers of 2,5-furandicarboxylic acid or C1-C6-dialkyl 2,5-furandicarboxylates, copolymers of terephthalic acid and 2,2,4,4-tetramethyl-1,3-cyclobutane diol, and combinations thereof.

In another aspect, the present invention relates to a polyol blend wherein the thermoplastic polyester is selected from PET, PETG, and PBT and mixtures thereof.

In another aspect, the present invention relates to a polyol blend wherein the thermoplastic polyester is PET, recycled PET, or combinations thereof.

In another aspect, the present invention relates to a polyol blend wherein the PET is recycled PET.

In another aspect, the present invention relates to a polyol blend wherein the polyester polyol component of the polyol blend has a hydroxyl number within the range of about 10 to about 500 mg KOH/g.

In another aspect, the present invention relates to a polyol blend wherein the polyester polyol component of the polyol blend has a hydroxyl number within the range of about 20 to about 400 mg KOH/g.

In another aspect, the present invention relates to a polyol blend wherein the polyester polyol component of the polyol blend has a hydroxyl number within the range of about 30 to about 300 mg KOH/g.

In another aspect, the present invention relates to a polyol blend that is substantially free of dialkyl naphthalene dicarboxylate and naphthalene dicarboxylic acid.

In another aspect, the present invention relates to a polyol blend that is substantially free of 2,2-dialkyl-1,3-propanediols.

In another aspect, the present invention relates to a polyol blend wherein the polyol is an oleochemical polyol.

In another aspect, the present invention relates to a polyol blend wherein the oleochemical polyol is selected from castor oil, ethoxylated castor oil, a polyol made by the hydrolysis or alcohololysis of epoxidized vegetable oil, a polyol made by the reaction between a glycol and an epoxidized fatty vegetable oil methyl ester, and combinations thereof; or wherein the oleochemical polyol is selected from castor oil, ethoxylated castor oil, a polyol derived from a vegetable oil or a fatty acid methyl ester, and combinations thereof.

In another aspect, the present invention relates to a polyol blend wherein the oleochemical polyol is castor oil.

In another aspect, the present invention relates to a polyol blend comprising, or consisting essentially of, or consisting of

(a) 30-70% by weight of a propoxylated bisphenol A;

(b) 70-30% by weight of a polyol selected from castor oil, ethoxylated castor oil and mixtures thereof.

In another aspect the present invention relates to a polyurethane comprising a polyol blend of the present invention.

In another aspect the present invention relates to an aqueous polyurethane dispersion comprising a polyol blend of the present invention.

In another aspect, the present invention relates to an aqueous polyurethane dispersion that is substantially free of melamine.

In another aspect, the present invention relates to an aqueous polyurethane dispersion that is substantially free of hydrogenated methylene diphenyl isocyanate or dicyclohexylmethane diisocyanate.

In another aspect the present invention relates to an aqueous polyurethane dispersion made from a polyol blend of the present invention.

In another aspect the present invention relates to a coating comprising a polyol blend of the present invention.

In another aspect the present invention relates to a coating comprising an aqueous polyurethane dispersion of the present invention.

In another aspect the present invention relates to a coating comprising an aqueous polyurethane dispersion of the present invention that is substantially free of melamine.

In another aspect the present invention relates to a coating comprising an aqueous polyurethane dispersion of the present invention that is substantially free of hydrogenated methylene diphenyl isocyanate or dicyclohexylmethane diisocyanate.

In another aspect the present invention relates to a floor coating for a flooring surface comprising a polyol blend of the present invention.

In another aspect the present invention relates to a floor coating for a flooring surface comprising an aqueous polyurethane dispersion of the present invention.

In another aspect the present invention relates to a floor coating for a flooring surface according to the present invention having an average dry film thickness from about 1 mil to about 100 mils, wherein the coating is achieved by either a single or multilayer coating application.

In another aspect the present invention relates to a floor coating for a flooring surface according to the present invention having an average dry film thickness from about 1 mil to about 10 mils, wherein the coating is achieved by either a single or multilayer coating application.

In another aspect the present invention relates to a floor coating for a flooring surface according to the present invention having an average dry film thickness from about 5 mils to about 7 mils, wherein the coating is achieved by either a single or multilayer coating application.

In another aspect the present invention relates to a floor coating for a flooring surface wherein the flooring is selected from concrete or wood.

In another aspect the present invention relates to a coated floor surface comprising a coating for a flooring surface (i.e. a floor coating) according to the present invention.

In another aspect the present invention relates to a coated floor surface wherein the floor surface is selected from concrete or wood.

In another aspect, the present invention relates to a coated floor surface wherein the resulting coating provides a surface that is not a release surface.

In another aspect, the present invention relates to a coated floor surface wherein the resulting coating provides a static coefficient of friction of 0.5 or greater as measured by ASTM C1028 or a dynamic coefficient of friction (DCOF) of 0.43 or greater when measured by ANSI standard 8101.3.

In another aspect, the present invention relates to a metal coating composition comprising the reaction product of:

(a) a polyol blend according to the present invention, and

(b) a crosslinker.

In another aspect, the present invention relates to a metal coating composition that is a direct-to-metal coating composition.

In another aspect, the present invention relates to a direct-to-metal coating composition wherein the crosslinker is selected from a melamine crosslinker, a diisocyanate trimer, a diisocyanate, or a polyisocyanate.

In another aspect, the present invention relates to a direct-to-metal coating composition wherein the coating is formulated at an NCO/OH ratio from 0.5 to 2.0.

In another aspect, the present invention relates to a direct-to-metal coating composition wherein the coating is formulated at an NCO/OH ratio from 0.5 to 1.5.

In another aspect, the present invention relates to a direct-to-metal coating composition wherein the coating is formulated at an NCO/OH ratio from 0.75 to 1.3.

In another aspect, the present invention relates to a direct-to-metal coating composition wherein the coating is formulated at an NCO/OH ratio of about 1.05.

In another aspect, the present invention relates to a direct-to-metal coating composition that is a polyurethane coating.

In another aspect, the present invention relates to a direct-to-metal coating composition that is a primer coating.

In another aspect, the present invention relates to a direct-to-metal coating composition further comprising titanium dioxide.

In another aspect, the present invention relates to a direct-to-metal coating composition that is substantially free of a corrosion inhibitor, i.e. corrosion inhibitor-free.

In another aspect, the present invention relates to a direct-to-metal coating composition further comprising a corrosion inhibitor.

In another aspect, the present invention relates to a direct-to-metal coating composition wherein the corrosion inhibitor is selected from zinc phosphate, zinc chromate, barium metaborate, calcium silica gel, amino carboxylate, barium phosphosilicate, aluminum triphosphate, and combinations thereof.

In another aspect, the present invention relates to a direct-to-metal coating composition wherein the corrosion inhibitor is zinc phosphate.

In another aspect, the present invention relates to a direct-to-metal coating composition that is a powder coating.

In another aspect, the present invention relates to a coated metal substrate comprising a coating comprising a metal coating composition comprising the reaction product of:

(a) a polyol blend according to the present invention, and

(b) a crosslinker.

In another aspect, the present invention relates to a coated metal substrate wherein the metal coating composition is a direct-to-metal coating composition.

In another aspect, the present invention relates to a coated substrate wherein the metal substrate is selected from aluminum, phosphated steel (such as cold-rolled phosphated steel or hot-rolled phosphated steel), oxidizable metals, galvanized metals, and plated metals.

In another aspect, the present invention relates to a coated substrate wherein the galvanized metals are selected from galvanized steel, hot-dipped galvanized steel, and electrogalvanized steel and the plated metals are selected from chromated aluminum.

In another aspect, the present invention relates to a coated substrate wherein the coated substrate has an improved 500 hour salt spray resistance as described herein when compared with that of a similar coated substrate prepared from a polyol blend produced without a polyphenol alkoxylate. In other words, the salt spray resistance comparison is made between a coated substrate wherein the coating is prepared from a polyol blend of the present invention versus a coated substrate, i.e. a “control coated substrate”, wherein the “control coating” is prepared from a polyol blend that is otherwise identical to the polyol blend of the present invention but without the polyphenol alkoxylate component. In further embodiments, this “control coating” is prepared without the polybisphenol-A carbonate (PBAC).

In another aspect, the present invention relates to a coated substrate wherein the coated substrate has an improved performance as per at least one testing standard selected from ASTM B117, ASTM D714, ASTM D610, or ASTM D1654, when compared with that of a similar coated substrate prepared from a polyester polyol produced without a polyphenol alkoxylate. In other words, the comparison is made using the selected ASTM testing standard, wherein the coating is prepared from a polyol blend of the present invention versus a coated substrate, i.e. a “control coated substrate”, wherein the “control coating” is prepared from a polyol blend that is otherwise identical to the polyol blend of the present invention but without the polyphenol alkoxylate component. In further embodiments, this “control coating” is prepared without the polybisphenol-A carbonate (PBAC).

In another aspect, the present invention relates to a polyol comprising recurring units derived from:

(a) a thermoplastic polyester,

(b) a bisphenol source selected from: a non-halogenated thermoplastic poly(bisphenol carbonate) and a non-halogenated bisphenol;

(c) a glycol; and

(d) a modifier selected from propylene carbonate, ethylene carbonate, propylene oxide, and ethylene oxide.

In another aspect, the present invention relates to a polyol wherein the thermoplastic polyester is a copolymer of an aromatic polyacid and a glycol, wherein
(a) the aromatic polyacid is selected from phthalic acid, terephthalic acid, 2,5-furandicarboxylic acid, isophthalic acid, dihydroferulic acid, salts thereof, C1-C6 monoesters thereof, C1-C6 diesters thereof, and combinations thereof; and
(b) the glycol is selected from ethylene glycol, 1,2-propanediol, 1,3-propanediol, 1,2-butanediol, 1,3-butanediol, 1,4-butanediol, 2,3-butanediol, neopentyl glycol, glycerol, trimethylolpropane, 3-methyl-1,5-pentanediol, 1,3-cyclohexane diol, 1,4-cyclohexane diol, 1,3-cyclohexanedimethanol, 1,4-cyclohexanedimethanol, diethylene glycol, tetraethylene glycol, dipropylene glycol, triethylene glycol, tripropylene glycol, polyethylene glycol, polypropylene glycol, 2,2,4,4-tetramethyl-1,3-cyclobutane diol, and block or random copolymer glycols of ethylene oxide and propylene oxide, and combinations thereof.

In another aspect, the present invention relates to a polyol wherein the bisphenol source is bisphenol-A.

In another aspect, the present invention relates to a polyol wherein the bisphenol source is poly(bisphenol A carbonate).

In another aspect, the present invention relates to a polyol wherein the glycol is selected from: ethylene glycol, 1,2-propanediol, 1,3-propanediol, 1,2-butanediol, 1,3-butanediol, 1,4-butanediol, 2,3-butanediol, neopentyl glycol, glycerol, trimethylolpropane, 3-methyl-1,5-pentanediol, 1,3-cyclohexane diol, 1,4-cyclohexane diol, 1,3-cyclohexanedimethanol, 1,4-cyclohexanedimethanol, diethylene glycol, tetraethylene glycol, dipropylene glycol, triethylene glycol, tripropylene glycol, polyethylene glycol, polypropylene glycol, 2,2,4,4-tetramethyl-1,3-cyclobutane diol, and block or random copolymer glycols of ethylene oxide and propylene oxide, and combinations thereof.

In another aspect, the present invention relates to a polyol wherein the polyol contains oligomers of poly(bisphenol carbonate).

In another aspect, the present invention relates to a polyol wherein the polyol further comprises a catalyst selected from a titanium-based catalyst, a tin-based catalyst, an inorganic metal carbonate or bicarbonate salt, sodium hydroxide, a tertiary amine, potassium hydroxide and mixtures thereof.

In another aspect, the present invention relates to a process for making a polyol blend comprising the steps of:

(a) glycolysis of a thermoplastic polyester to produce a polyester polyol intermediate;

(b) glycolysis of a thermoplastic poly(bisphenol-A) carbonate using the intermediate from step (a) to form a co-glycolyzed intermediate; and

(c) modification of the co-glycolized intermediate from step (b) by reaction with a modifier selected from propylene carbonate, ethylene carbonate, propylene oxide, ethylene oxide, an aliphatic C2-C12 carboxylic acid, a glycidyl ether, a diglycidyl ether, an aliphatic or cycloaliphatic C4-C36 dicarboxylic acid, or mixtures thereof, to produce the blend.

In another aspect, the present invention relates to a process wherein step (c) further comprises a catalyst.

In another aspect, the present invention relates to a process wherein the catalyst is selected from an inorganic carbonate or bicarbonate salt, an alkali metal hydroxide salt, a tertiary amine, and mixtures thereof.

In another aspect, the present invention relates to a process wherein the thermoplastic polyester is a copolymer of an aromatic polyacid and a glycol, wherein
(a) the aromatic polyacid is selected from phthalic acid, terephthalic acid, 2,5-furandicarboxylic acid, isophthalic acid, dihydroferulic acid, salts thereof, C1-C6 monoesters thereof, C1-C6 diesters thereof, and combinations thereof; and
(b) the glycol is selected from ethylene glycol, 1,2-propanediol, 1,3-propanediol, 1,2-butanediol, 1,3-butanediol, 1,4-butanediol, 2,3-butanediol, neopentyl glycol, glycerol, trimethylolpropane, 3-methyl-1,5-pentanediol, 1,3-cyclohexane diol, 1,4-cyclohexane diol, 1,3-cyclohexanedimethanol, 1,4-cyclohexanedimethanol, diethylene glycol, tetraethylene glycol, dipropylene glycol, triethylene glycol, tripropylene glycol, polyethylene glycol, polypropylene glycol, 2,2,4,4-tetramethyl-1,3-cyclobutane diol, and block or random copolymer glycols of ethylene oxide and propylene oxide, and combinations thereof.

In another aspect, the present invention relates to a process for making a polyol blend comprising the steps of:

(a) glycolysis of a thermoplastic polyester and a thermoplastic poly(bisphenol-A) carbonate to form a co-glycolyzed intermediate; and

(b) modification of the co-glycolized intermediate from step (a) by reaction with a modifier selected from propylene carbonate, ethylene carbonate, propylene oxide, ethylene oxide, an aliphatic C2-C12 carboxylic acid, a glycidyl ether, a diglycidyl ether, an aliphatic or cycloaliphatic C4-C36 dicarboxylic acid, or mixtures thereof, to produce the blend.

In another aspect, the present invention relates to a process for making a polyol blend comprising the steps of:

(a) glycolysis of a thermoplastic poly(bisphenol-A) carbonate to produce a glycolyzed intermediate;

(b) glycolysis of a thermoplastic polyester using the intermediate from step (a) to form a co-glycolyzed intermediate; and

(c) modification of the co-glycolized intermediate from step (b) by reaction with a modifier selected from propylene carbonate, ethylene carbonate, propylene oxide, ethylene oxide, an aliphatic C2-C12 carboxylic acid, a glycidyl ether, a diglycidyl ether, an aliphatic or cycloaliphatic C4-C36 dicarboxylic acid, or mixtures thereof, to produce the blend.

In another aspect, the present invention relates to a polyol blend comprising:
(a) a polyol selected from a polyester polyol, a polyether polyol, a polycarbonate polyol, a polyester/carbonate polyol, a polyether/ester polyol, an acrylic polyol, an oleochemical polyol, and combinations thereof; and
(b) a tristyryl phenol alkoxylate.

In another aspect, the present invention relates to a polyol blend wherein the tristyryl phenol alkoxylate is a tristyryl phenol ethoxylate.

In another aspect, the present invention relates to a polyol blend wherein the tristyryl phenol alkoxylate is a tristyryl phenol ethoxylate having about 16 units of ethylene oxide.

In another aspect, the present invention relates to a substantially isocyanate-free polyurethane prepared from a polyol blend according to the present invention.

In another aspect, the present invention relates to a method for preparing a substantially isocyanate-free polyurethane comprising the steps of:

(a) reacting a polyol blend according to the present invention with an alkyl carbamate or urea to form a polycarbamate, and
(b) reacting the polycarbamate from step (a) with a polyaldehyde or an acetal or hemiacetal thereof in the presence of a triggering agent to form the polyurethane.

In another aspect, the present invention relates to a wherein the polyaldehyde is selected from cis-1,3-cyclohexanedicarboxaldehyde, trans-1,3-cyclohexanedicarboxyaldehyde, cis 1,4-cyclohexanedicarboxaldehyde, trans 1,4-cyclohexanedicarboxyaldehyde, acetals or hemiacetals thereof, and mixtures thereof.

In another aspect, the present invention relates to a method wherein the triggering agent is an acid with a pKa of less than 6.0 or a Lewis acid.

In another aspect, the present invention relates to a method wherein the alkyl carbamate is selected from methyl carbamate, ethyl carbamate, and mixtures thereof.

In another aspect, the present invention relates to a method wherein the alkyl carbamate is methyl carbamate.

In another aspect, the present invention relates to a method for preparing a polyurethane comprising the steps of:

(a) reacting a polyol blend according to the present invention with a di- or polyisocyanate to form a polymeric di- or polyisocyanate intermediate;

(b) reacting of the polymeric polyisocyanate intermediate from step (a) with a hydroxyalkyl carbamate to form a polycarbamate, and

(c) reacting the polycarbamate from step (b) with a polyaldehyde or an acetal or hemiacetal thereof in the presence of a triggering agent to form the polyurethane.

In another aspect, the present invention relates to a method wherein the di- or polyisocyanate is selected from hexamethylene diisocyanate, methylenebis(phenyl isocyanate) (MDI), polymeric methylene bis(phenyl isocyanate), toluene diisocyanate (TDI), hexamethylene diisocyanate (HDI), naphthalene diisocyanate (NDI), methylene bis-cyclohexylisocyanate (HMDI), isophorone diisocyanate (IPDI), xylylene diisocyanate, hydrogenated xylylene diisocyanate, 2,2,4-trimethyl hexamethylene diisocyanate, 2,4,4-trimethyl hexamethylene diisocyanate pentamethylene 1,5-diisocyanate, derivatives of the foregoing, and combinations thereof.

In another aspect, the present invention relates to a method for preparing a polyurethane wherein the di- or polyisocyanate is substantially free of toluene diisocyanate.

In another aspect, the present invention relates to a method wherein the hydroxyalkyl carbamate is hydroxyethyl carbamate.

In another aspect, the present invention relates to a method wherein the polyaldehyde is selected from cis-1,3-cyclohexanedicarboxaldehyde, trans-1,3-cyclohexanedicarboxyaldehyde, cis 1,4-cyclohexanedicarboxaldehyde, trans 1,4-cyclohexanedicarboxyaldehyde, acetals or hemiacetals thereof, and mixtures thereof.

In another aspect, the present invention relates to a method for preparing a glycolyzed intermediate blend comprising the steps of:

(a) glycolyzing a thermoplastic polyester in a first reactor with a glycol;

(b) glycolyzing a thermoplastic poly(bisphenol carbonate) in a second reactor with a glycol, followed by reaction with a scavenger to minimize the amount of free bisphenol produced, and

(c) combining the glycolyzed product from step (a) and step (b) to form a glycolyzed intermediate blend.

In another aspect, the glycol used in the first reactor or the second reactor is selected from ethylene glycol, 1,2-propanediol, 1,3-propanediol, 1,2-butanediol, 1,3-butanediol, 1,4-butanediol, 2,3-butanediol, neopentyl glycol, glycerol, trimethylolpropane, 3-methyl-1,5-pentanediol, 1,3-cyclohexane diol, 1,4-cyclohexane diol, 1,3-cyclohexanedimethanol, 1,4-cyclohexanedimethanol, diethylene glycol, tetraethylene glycol, dipropylene glycol, triethylene glycol, tripropylene glycol, polyethylene glycol, polypropylene glycol, 2,2,4,4-tetramethyl-1,3-cyclobutane diol, and block or random copolymer glycols of ethylene oxide and propylene oxide, and combinations thereof.

In another aspect, the present invention relates to a method wherein the scavenger is selected from selected from propylene carbonate, ethylene carbonate, propylene oxide, ethylene oxide, an aliphatic C2-C12 carboxylic acid, a glycidyl ether, a diglycidyl ether, a C4-C36 aliphatic or cycloaliphatic dicarboxylic acid or mixtures thereof.

In another aspect, the present invention relates to a method for making an additive for a polyol blend, comprising:

(a) glycolyzing a thermoplastic poly(bisphenol carbonate) using a single glycol, whereby the target molecular weight of the glycolysis product is achieved by adjusting the ratio of the moles of the repeat polycarbonate units to the moles of glycol; and

(b) optionally, reacting the glycolysis product from step (a) with a scavenger to minimize the amount of free bisphenol produced from step (a).

In another aspect, the present invention relates to a method according to claim 88 wherein the single glycol is selected from ethylene glycol, 1,2-propanediol, 1,3-propanediol, 1,2-butanediol, 1,3-butanediol, 1,4-butanediol, 2,3-butanediol, neopentyl glycol, glycerol, trimethylolpropane, 3-methyl-1,5-pentanediol, 1,3-cyclohexane diol, 1,4-cyclohexane diol, 1,3-cyclohexanedimethanol, 1,4-cyclohexanedimethanol, diethylene glycol, tetraethylene glycol, dipropylene glycol, triethylene glycol, tripropylene glycol, polyethylene glycol, polypropylene glycol, 2,2,4,4-tetramethyl-1,3-cyclobutane diol, and block or random copolymer glycols of ethylene oxide and propylene oxide, and combinations thereof.

In another aspect, the present invention relates to a method according to claim 88 wherein the scavenger is selected from selected from propylene carbonate, ethylene carbonate, propylene oxide, ethylene oxide, an aliphatic C2-C12 carboxylic acid, a glycidyl ether, a diglycidyl ether, a C4-C36 aliphatic or cycloaliphatic dicarboxylic acid or mixtures thereof.

In another aspect, the present invention relates to an additive made by the process of the present invention.

In another aspect, the present invention relates to a blend comprising the additive of the present invention and a polyol.

In another aspect, the present invention relates to a process for making a polymeric coating comprising the steps of:

(I) making a polyol blend comprising the steps of:

(a) glycolysis of a thermoplastic polyester to produce a polyester polyol intermediate;

(b) glycolysis of a thermoplastic poly(bisphenol-A) carbonate using the intermediate from step (a) to form a co-glycolyzed intermediate; and

(c) modification of the co-glycolized intermediate from step (b) by reaction with a modifier selected from propylene carbonate, ethylene carbonate, propylene oxide, ethylene oxide, an aliphatic C2-C12 carboxylic acid, a glycidyl ether, a diglycidyl ether, an aliphatic or cycloaliphatic C4-C36 dicarboxylic acid, or mixtures thereof, to produce the blend;

(II) reacting the polyol blend from step (I) with a C2 to C18 aliphatic or aromatic diacid.

These and other aspects of the invention will become apparent from the disclosure herein.

### Definitions

As used herein, the following terms have the indicated meanings unless expressly stated to the contrary:

The term “blend” as used herein relates to a physical mixture of two or more substances to a homogeneous state, such that they do not subsequently or appreciably separate.

The term “coated substrate” as used herein means a substrate or base material that is covered by or “coated” by the coating material.

The term “coating” as used herein and described in more detail below refers to a covering or layer of a material, i.e. the coating material that is applied to the surface of a substrate.

The term “direct-to-metal”, abbreviated “DTM” refers to a coating composition that is applied directly to a metal substrate without an adhesive or other intermediate material.

The term “glycolysis” as used herein is from the field of polymer chemistry where it refers to the digestion of a polymer with a glycol via a chemical reaction to yield lower molecular weight fragments, such as for example, oligomers and monomers.

The term “improved performance” as used herein refers to the performance of a coated substrate wherein the coated substrate has an improved performance as per at least one testing standard selected from ASTM B117, ASTM D714, ASTM D610, or ASTM D1654, when compared with that of a similar coated substrate prepared with a coating prepared from a polyester polyol without an alkoxylated polyphenol. The performance comparison is made using the ASTM testing standard, wherein the coating is prepared from a polyol blend of the present invention versus a coated substrate, i.e. a “control coated substrate”, wherein the “control coating” is prepared from a polyol blend that is otherwise identical to the polyol blend of the present invention but without the polyphenol alkoxylate component. In further embodiments, this “control coating” is prepared without the polybisphenol-A carbonate (PBAC).

The term “improved salt spray performance” as used herein refers to the performance of a coated substrate wherein the coated substrate has an improved 500 hour salt spray resistance when compared with that of a similar coated substrate with a coating prepared from a polyester polyol without an alkoxylated polyphenol. This improved performance as measured by millimeters of creep from the scribe, the ratings in the field in terms of blister size and number, and corrosion in the field (i.e. not adjacent to the scribe in the panel). In other words, the salt spray resistance comparison is made between a coated substrate wherein the coating is prepared from a polyol blend of the present invention versus a coated substrate, i.e. a “control coated substrate”, wherein the “control coating” is prepared from a polyol blend that is otherwise identical to the polyol blend of the present invention but without the polyphenol alkoxylate component. In further embodiments, this “control coating” is prepared without the polybisphenol-A carbonate (PBAC). It should be noted that other time points can be selected such as 1000 hours, 1500 hours, 2000, hours, and 3000 hours.

Where improved performance can be quantified, in certain embodiments the improved performance can be defined as at least a 1 percent incremental difference, in other embodiments at least a 2 percent incremental difference, in other embodiments at least a 5 percent incremental difference, in other embodiments, at least a 10 percent incremental difference, and in other embodiments at least a 25 percent incremental difference, versus the comparator.

The term “NCO/OH ratio” or “NCO/OH index” refers to isocyanate to hydroxyl number ratio.

The term “non-isocyanate polyurethane” or “NIPU”, refers to polyurethanes that are prepared without using isocyanates. Generally, polyurethanes are commercially produced by the reaction of diisocyanates and polyols such as polyesters or polyethers. Because NIPUs are prepared without diisocyanates they can have safety and environmental advantages because these materials would be substantially free of isocyanate contaminants, such that there is little or no residual isocyanate. Generally, the residual levels should be less than about 1000 ppm by weight of the polyol blend or in further embodiments less than about 250 ppm by weight of the polyol blend.

The term “recycled polymer” as used herein refers to a polymer that has little value after its original lifespan has ended, and is recovered in an economically viable fashion from the original spent application for use in other applications.

The terms “having substantially no free polyphenol contaminant” and “substantially no free polyphenol contaminant” means that the levels of polyphenol contaminant, is such that the compositions have little or no residual polyphenol. Generally, the residual levels should be less than about 1000 ppm by weight of the blend or in further embodiments less than about 250 ppm by weight of the blend. More specifically the compositions are “substantially free” of polybisphenol-A (PBA) in that they have substantially no free PBA, with such levels generally less than about 1000 ppm by weight of the blend, or further less than about 250 ppm by weight of the blend.

The term “having a low VOC emission”, means that the VOC level is such to comport with current US Federal and State standards.

The term “suitable for forming a coating means a composition of the present invention that provides properties desirable in a coating, particularly coatings for substrates such as metals and the like. These coatings should demonstrate salt spray resistance, rub resistance, solvent resistance, etc. as described herein.

The terms “waste stream” as used herein refers to waste or discarded products from industry, agriculture, or consumer sources that has few ultimate destinations or applications other than for example, landfill, incineration, animal feed, concrete, burning as a source of energy, fertilization, landscaping mulch, or other relatively low value applications.

The term “substrate” as used herein generally refers to a solid material which can be covered by a coating. In general, the substrates herein are preferably metal substrates.

Polyol Blends

The polyol blends of the present invention comprise a polyol and a polyphenol alkoxylate. The polyol is selected from a polyester polyol, a polyether polyol, a polycarbonate polyol, a polyester/carbonate polyol, a polyether/ester polyol, an acrylic polyol, poly(1,3-propanediol), an oleochemical polyol, polyaspartic esters, polytetrahydrofurans, and combinations thereof.

Polyphenol Alkoxylate Containing Blends and Coatings

We have tapped non-petroleum and non-bio resources for producing high performance industrial coating resins. We provide multi-functional materials as base resins or blend additives, which are based on polycarbonate streams. In some embodiments we provide polyols that contain high levels of recycled materials. These polyols provide a green chemistry option for heavy metal corrosion pigments, are non-toxic, can be added during the letdown stage of coating production, and can enhance other coating performance properties.

Polyphenol Alkoxylates

The coatings and blends herein comprise a polyphenol alkoxylate, which can alternatively be referred to as an alkoxylated polyphenol.

These alkoxylates can be ethoxylates, propoxylates, or mixed ethoxylates/propoxylates. A “polyphenol” has at least two phenolic hydroxyl groups, which can be on the same or different phenylene (benzene) rings, but are preferably on different phenylene rings. At least two of the phenylene rings lack a “common molecular axis.” In such compounds, the linking group between the phenylene rings prevents the rings from sharing a common molecular axis. The linking group is often a carbon- or sulfur-containing linking group. In bisphenol A, for instance, two phenolic units are separated by a —C(CH₃)₂— group. In contrast, consider 4,4′-dihydroxybiphenyl, where the phenylene rings are joined directly together and share a common molecular axis.

Suitable polyphenols include bisphenols such as bisphenol A (from acetone and phenol), bisphenol AP (from acetophenone and phenol), bisphenol AF (from hexafluoroacetone and phenol), bisphenol B (from methyl ethyl ketone and phenol), bisphenol BP (from benzophenone and phenol), bisphenol C (from acetone and cresol), bisphenol E (from acetaldehyde and phenol), bisphenol F (from formaldehyde and phenol), bisphenol G (from acetone and 2-isopropylphenol), bisphenol PH (from acetone and 2-phenylphenol), bisphenol Z (from cyclohexanone and phenol), and the like, and alkoxylates or polycarbonates made from these. Suitable sulfonyl diphenols include, for example, bisphenol S (from sulfur trioxide and phenol, also known as 4,4′-sulfonyldiphenol), 4,4′-sulfonyldicresol (from sulfur trioxide and cresol), and the like, and alkoxylates or polycarbonates made from these.

In certain embodiments, the alkoxylated polyphenol may be the alkoxylated product of the reaction of phenol with a ketone containing an aliphatic carboxylic acid. One example of this type of alkoxylated bisphenol is alkoxylated 4,4-bispentanoic acid, also commonly known as diphenolic acid. The bisphenol precursor is a result of the condensation reaction of phenol with levulinic acid in the presence of an acid catalyst such as, for example, hydrochloric acid. Diphenolic acid may be alkoxylated using propylene oxide, ethylene oxide, or mixtures thereof. Examples of alkoxylation of carboxylic acids such as the one found on diphenolic acid may be found in the Journal of the American Oil Chemists Society 1956; 33(11) pages 571-574 and in the Journal of the American Oil Chemists' Society, 1967; 44(1) pages 40-42. Examples of the alkoxylation of a phenol using an alkylene carbonate are provided in U.S. Pat. Nos. 4,261,922 and 5,679,871. 4,846,996 teaches the alkoxylation of bisphenols using ethylene oxide and propylene oxide.

In certain embodiments the polyphenol alkoxylate may be the reaction product of a mono-carboxylic acid with a polyphenol polyglycidyl ether. For example, it is well known that bisphenol A diglycidyl ether may be reacted with various mono-carboxylic acids, optionally in the presence of a catalyst, to form diols suitable for use in the practice of this invention according to the chemical reaction scheme shown below:

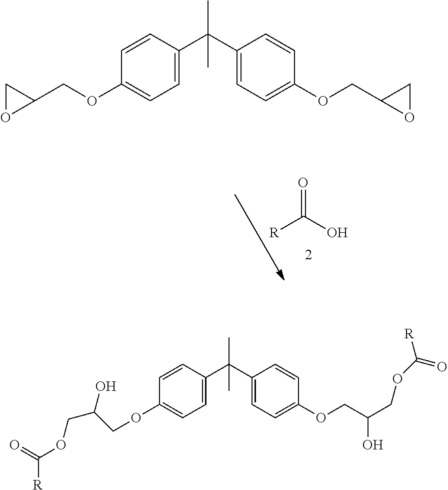

In a similar manner, other polyphenol polyglycidyl ethers may be reacted with various aliphatic, benzylic, aromatic, and cycloaliphatic mono-carboxylic acids, optionally in the presence of a catalyst to form diols and polyols that can be classified as polyphenol alkoxylates according to the practice of this invention. Examples of polyphenol polyglycidyl ethers suitable for reaction with mono-carboxylic acids to form polyphenol alkoxylates suitable for the practice of this invention include bisphenol F diglycidyl ether, novolac epoxy resins; resol epoxy resins; and bisphenols S, AP, AF, B, BP, C, C2, E, G, M, P, PH, TMC and Z diglycidyl ethers; and mixtures thereof.

In certain embodiments the polyphenol alkoxylate may be the reaction product of a mono-phenol with a polyphenol polyglycidyl ether, preferably in the presence of a base catalyst to form polyphenol alkoxylates suitable for the practice of this invention. Examples of polyphenol polyglycidyl ethers suitable for reaction with mono-phenols to form polyphenol alkoxylates suitable for the practice of this invention include bisphenol F diglycidyl ether; novolac epoxy resins; resol epoxy resins; and bisphenol A, S, AP, AF, B, BP, C, C2, E, G, M, P, PH, TMC and Z diglycidyl ethers; and mixtures thereof.

In certain embodiments the polyphenol alkoxylate may be the reaction product of a mono-alcohol with a polyphenol polyglycidyl ether, preferably in the presence of a catalyst to form polyphenol alkoxylates suitable for the practice of this invention. Examples of polyphenol polyglycidyl ethers suitable for reaction with mono-alcohols to form polyphenol alkoxylates suitable for the practice of this invention include bisphenol F diglycidyl ether; novolac epoxy resins; resol epoxy resins; and bisphenol A, S, AP, AF, B, BP, C, C2, E, G, M, P, PH, TMC and Z diglycidyl ethers; and mixtures thereof.

The term ring opened polyglycidyl ether is used herein to indicate the reaction product of a polyglydicyl ether with aliphatic, benzylic, aromatic, and cycloaliphatic mono-carboxylic acids, mono-alcohols or mono-phenols, optionally in the presence of a catalyst.

In certain embodiments, the alkoxylated polyphenol is an alkoxylated bisphenol-A, such as an ethoxylated bisphenol-A, a propoxylated bisphenol-A, or a mixed ethoxylate/propoxylate of bisphenol-A. Bisphenol-A is also known by the IUPAC name 4,4′-(propane-2,2-diyl)diphenol and has the CAS number 80-05-07 and can be represented by the following chemical structure:

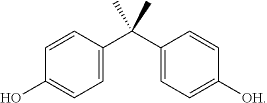

Propoxylated bisphenol-A has been found to be useful herein, an example of which is a bisphenol-A propoxylate comprising between 1 and 4 propylene oxide groups per phenolic hydroxyl group.

In other aspects, triphenol alkoxylates are useful such that the polyphenol component is a triphenol.

In other aspects, the phenol alkoxylates are tristyryl phenol alkoxylates, an example of such a compound is a tristyryl phenol ethoxylate.

In some aspects, the polyphenol alkoxylates can be non-halogentated compounds. In other words, the polyphenol component of the alkoxylate is a non-halogenated polyphenol. More specifically, the bisphenol alkoxylate would be a non-halogentated bisphenol alkoxylate or the triphenol alkoxyate would be a non-halogenated triphenol alkoxylate.

We surprisingly found that incorporation of, or the reaction with, certain compounds such as polyphenol alkoxylates into polyester polyols produced from digested thermoplastic polyesters, especially recycled PET, provides blends that have desirable viscosity and low VOC properties and which are useful for preparing high-performance coatings.

The polyphenol alkoxylate is used in an amount within the range of 0.1 to 50 wt. % based on the amount of polyester polyol. In other aspects, 0.5 to 40 wt. %, or 1.0 to 30 wt. %, or 2.0 to 15 wt. % of the bis- or polyphenol alkoxylate can be used.

In other aspects, the phenol alkoxylate can be a monophenol alkoxyate. Such an example would be a tristyryl phenol alkoxylate, i.e. a phenol with three styryl groups. An example of such a compound is a tristyryl phenol ethoxylate (a polyethylene glycol mono(tristyrylphenyl)ether), such as tristyrylphenol ethoxylated with 16 moles of ethylene oxide, available as Polystep TSP16 from Stepan. See CAS Registry Number 99734-09-5.

Polyols

The compositions of the present invention comprise a polyol. The polyol is selected from a polyester polyol, a polyether polyol, a polycarbonate polyol, a polyester/carbonate polyol, a polyether/ester polyol, an acrylic polyol, an oleochemical polyol, and combinations thereof. In other embodiments the polyol is selected from a polyester polyol, a poly-THF ether, a poly-(1,3,-propanediol) ether, a polyester/carbonate polyol, a polyether/ester polyol, an oleochemical polyol, and combinations thereof.

Polyols are extensively described in Chemistry and Technology of Polyols for Polyurethanes, by Mihail lonescu, Rapra Technology Limited, Shrewsbury, U.K. (2005), which is incorporated by reference herein in its entirety.

Polyester Polyols

The polyester polyols can also be described as the reaction product of a polyacid source, such as an aromatic or an aliphatic polyacid source, and a glycol.

Aromatic Polyacid Source

The polyester polyol can contain recurring units derived from an aromatic polyacid source. The term “aromatic polyacid source” is used to designate that the material or source contains one or more aromatic acid moieties or groups.

The term “aromatic polyacid source” is used to designate that the material or source contains one or more aromatic acid moieties or groups. Chemical Structure 1, below, provides an illustration of an Aromatic Polyacid Source.

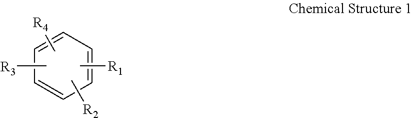

Where R₁ and R₂ are carboxylate groups; and R₃ and R₄ are selected from carboxylate group or hydrogen.

Chemical Structure 2, below provides another illustration of an Aromatic Polyacid Source.

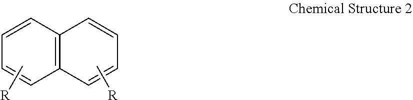

Where both R groups are carboxylic acid groups or alkyl ester groups.

Chemical Structure 3, below, provides another illustration of an Aromatic Polyacid Source.

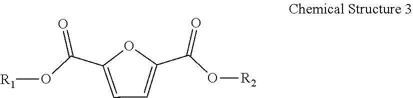

Where R₁ and R₂ are selected independently from either an alkyl group or hydrogen.

The aromatic polyacid source includes polyesters such as thermoplastic polyesters. These include polyesters polymers prepared by the reaction of one or more difunctional and/or multifunctional aromatic carboxylic acids, i.e. polycarboxylic acids, with one or more difunctional hydroxyl compounds and/or multifunctional hydroxyl compounds, wherein the difunctional hydroxyl compounds, or glycols.

Examples of materials that contain aromatic polyacid groups suitable for the practice of the invention include phthalic acid, phthalic anhydride, dimethyl phthalates, dialkyl phthalates, terephthalic acid, dimethyl terephthalates, dialkyl terephthalate, isophthalic acid, dimethyl isophthalates, dialkyl isophthalates, DMT bottoms (for example, as described in U.S. Pat. Nos. 5,075,417; 4,897,429; 3,647,759; 4,411,949; 4,714,717; and 4,897,429; which are incorporated by reference herein in their entirety), trimellitic acid, trimellitic anhydride, trimethyl trimellitate, pyromellitic anhydride, 2,5-furandicarboxylic acid, dialkyl 2,5-furandicarboxylate, pyromellitic acid, dialkyl naphthalene dicarboxylate, and mixtures thereof.

Also, the term “terephthalic acid” is intended to include terephthalic acid itself and residues thereof as well as any derivative of terephthalic acid, including its associated acid halides, esters, half-esters, salts, half-stats, anhydrides, mixed anhydrides, or mixtures thereof or residues thereof useful in a reaction process with a diol to make a polyester.

Aromatic polyacid sources may also be obtained from thermoplastic polyesters. Thermoplastic polyesters suitable for use are well known in the art. They are condensation polymers produced from the reaction of glycols and aromatic polycarboxylic acids or polycarboxylic acid derivatives, such as dicarboxylic acids or dicarboxylic acid derivatives. Examples include polyethylene terephthalate (PET), polybutylene terephthalate (PBT), polytrimethylene terephthalate (PTT), glycol-modified polyethylene terephthalate (PETG), copolymers of terephthalic acid and 1,4-cyclohexanedimethanol (PCT), copolymers of 2,5-furandicarboxylic acid or dialkyl 2,5-furandicarboxylates and at least one glycol, PCTA (an isophthalic acid-modified PCT), copolymers of naphthalene dicarboxylic acid or dialkyl naphthalene dicarboxylate and the like, and mixtures thereof.

Some examples of thermoplastic polyesters are copolymers of an aromatic polyacid and a glycol as defined herein, wherein the aromatic polyacid is selected from phthalic acid, terephthalic acid, 2,5-furandicarboxylic acid, isophthalic acid, dihydroferulic acid, salts thereof, C1-C6 monoesters thereof, C1-C6 diesters thereof, and combinations thereof; and the glycol is selected from ethylene glycol, 1,2-propanediol, 1,3-propanediol, 1,2-butanediol, 1,3-butanediol, 1,4-butanediol, 2,3-butanediol, neopentyl glycol, glycerol, trimethylolpropane, 3-methyl-1,5-pentanediol, 1,3-cyclohexane diol, 1,4-cyclohexane diol, 1,3-cyclohexanedimethanol, 1,4-cyclohexanedimethanol, diethylene glycol, tetraethylene glycol, dipropylene glycol, triethylene glycol, tripropylene glycol, polyethylene glycol, polypropylene glycol, 2,2,4,4-tetramethyl-1,3-cyclobutane diol, and block or random copolymer glycols of ethylene oxide and propylene oxide, and combinations thereof.

Suitable thermoplastic polyesters include virgin polyesters, recycled polyesters, or mixtures thereof. Polyethylene terephthalate (PET) is particularly preferred, especially recycled polyethylene terephthalate (rPET), virgin PET, and mixtures thereof. For more examples of suitable thermoplastic polyesters, see U.S. Pat. Appl. Publ. No. 2009/0131625, which is incorporated by reference herein in its entirety.

Recycled polyethylene terephthalate suitable for use in making the inventive polyester polyols can come from a variety of sources. The most common source is the post-consumer waste stream of PET from plastic bottles or other containers. The rPET can be colorless or contain dyes (e.g., green, blue, brown, or other colors) or be mixtures of these. A minor proportion of organic or inorganic foreign matter (e.g., paper, other plastics, glass, metal, etc.) can be present. A desirable source of rPET is “flake” rPET, from which many of the common impurities present in scrap PET bottles have been removed in advance. Another desirable source of rPET is pelletized rPET, which is made by melting and extruding rPET through metal filtration mesh to further remove particulate impurities. Because PET plastic bottles are currently manufactured in much greater quantity than any recycling efforts can match, scrap PET will continue to be available in abundance. Other sources of PET include, PET textiles and PET carpeting, such as recycled PET textiles and recycled PET carpeting. For example, recycled PET polyester carpet including polyolefin backing, calcium carbonate filler, and latex adhesive, assuming an approximate PET composition of 90% of the carpet, is a useful source material to prepare the digested intermediate.

Polytrimethylene terephthalate (PTT) is another useful polyaromatic source, and like PET, can be obtained from PTT textiles and PTT carpeting, such as recycled PTT textiles and recycled PTT carpeting. For example, recycled PTT polyester carpet including polyolefin backing, calcium carbonate filler, and latex adhesive, assuming an approximate PTT composition of 90% of the carpet, is a useful source material to prepare the digested intermediate.

Other useful polyaromatic sources are polyesters made from polyaromatics and rigid diols such as cycloalkane diols, examples of such rigid diols including 2,2,4,4-tetramethyl-1,3-cyclobutanediol, 1,3-cycohexane diol, 1,4-cyclohexane diol, 1,3-cyclohexanedimethanol, and 1,4-cyclohexanedimethanol. Such examples include terephthalate copolyesters of 2,2,4,4-tetramethyl-1,3-cyclobutanediola, and also polyesters which also contain flexible diols, such as C2-C6 linear or branched aliphatic diols. Examples of these polyesters include, for example Eastman Tritan materials from post consumer recycle of water bottles See, also, U.S. Patent Application No. US 2013/0072628 A1, to Crawford et al., published Mar. 21, 2013; and D. R. Kelsey et al., High Impact, Amorphous Terephthalate Copolyesters of Rigid 2,2,4,4-Tetramethyl-1,3-cyclobutanediol with Flexible Diols, Macromolecules, 2000, 33, 5810-5818; which are incorporated by reference herein in their entirety.

Aliphatic Polyacid Source

The polyester polyol can contain recurring units derived from an aliphatic polyacid source. The term “aliphatic polyacid source” is used to designate that the material or source contains one or more aliphatic acid moieties or groups.

Examples of aliphatic polyacid sources include the mono- or dialkyl esters of maleic anhydride or succinic anhydride, the mono- or dialkyl esters of succinic acid, maleic acid, lactic acid, fumaric acid, suberic acid, sebacic acid, azelaic acid, adipic acid, malonic acid, glutaric acid, nonandioic acid, nonenedioic acid, sebacic acid, decenedioic acid, dodecanedioic acid, dodecenedioic acid, tetradecanedioic acid, tetradecenedioic acid, hexadecanedioic acid, octadecanedioic acid, decenedioic or its mono- or dialkyl esters, and mixtures thereof. Preferably, the aliphatic polyacid source is selected from adipic acid, suberic acid, sebacic acid, succinic acid, nonanedioic acid, octadecanedioic acid, decenedioic hexadecanedioic acid or its mono- or dialkyl esters, and mixtures thereof.

Furthermore, when the polyester polyols are aliphatic polyester polyols, they can be derived from aliphatic polyacid sources, where the aliphatic polyacid source is reacted with a glycol stream and preferably also a hydrophobe.

Unsaturated polyester resins are produced by chemical reaction of saturated and unsaturated di-carboxylic acids with alcohols. Unsaturated polyester resins are usually supplied as a mixture with a vinyl reactive monomer, most commonly styrene. In one aspect of the practice of this invention, it is preferred that the polyester polyols as defined herein are substantially free of styrene. In another aspect of the practice of this invention, it is further preferred that the polyester polyols as defined herein are substantially free of acrylate monomers.

Catalysts

Catalysts suitable for making the digested intermediate are well known (see, e.g., K. Troev et al., J. Appl. Polym. Sci. 90 (2003) 1148). In particular, suitable catalysts comprise titanium, zinc, antimony, germanium, zirconium, manganese, or other metals. Specific examples include titanium alkoxides (e.g., tetrabutyl titanate), titanium(IV) phosphate, zirconium alkoxides, zinc acetate, lead acetate, cobalt acetate, manganese(II) acetate, antimony trioxide, germanium oxide, or the like, and mixtures thereof. Catalysts that do not significantly promote isocyanate reaction chemistries are preferred. The amount of catalyst used is typically in the range of 0.005 to 5 wt. %, preferably 0.01 to 1 wt. %, more preferably 0.02 to 0.7 wt. %, based on the total amount of polyol being prepared.

The hydrolysis and chemolysis of the digestible polymer can be catalyzed by the use of enzymes such as proteases; lipases; amylases; maltases; sucrases; lactases; esterases; hydrolases; amidases; glycosidases; glycoside hydrolases; peptidases and the like and mixtures thereof. Subsequent reaction of the resulting hydrolysis or chemolysis products with the digested intermediate may then be facilitated by enzymes such as lipases; amidases and esterases.

The reaction of the digestible polymer with the digested intermediate can also be catalyzed by the use of acids or bases, including carboxylic acids.

Glycols

Glycols suitable for use are well known. By “glycol,” we mean a linear or branched, aliphatic or cycloaliphatic compound or mixture of compounds having two or more hydroxyl groups. Other functionalities, particularly ether or ester groups, may be present in the glycol. In preferred glycols, two of the hydroxyl groups are separated by from about 2 to about 20 carbons, preferably from about 2 to about 14 carbon atoms, and more preferably from about 2 to about 8 carbons. Note that ether linkages may be included in the carbon separation between hydroxyl groups, though the oxygen atoms are not included in the carbon count. Suitable glycols include, for example, ethylene glycol, propylene glycol, 1,3-propanediol, 1,2-butylene glycol, 1,3-butylene glycol, 1,4-butanediol, 2-methyl-1,3-propanediol, neopentyl glycol, glycerol, trimethylolpropane, 3-methyl-1,5-pentanediol, 1,4-cyclohexane-dimethanol, diethylene glycol, dipropylene glycol, triethylene glycol, 1,6-hexanediol, tripropylene glycol, tetraethylene glycol, polyethylene glycols (PEGs), polypropylene glycols (PPGs), and block or random copolymer glycols of ethylene oxide and propylene oxide, and the like, and mixtures thereof. Preferably, the glycol is selected from ethylene glycol, propylene glycol, 2-methyl-1,3-propanediol, diethylene glycol, 3-methyl-1,5-pentanediol, neopentyl glycol, and polyethylene glycols with molecular weights less than about 600 (e.g., PEG 200 and PEG 400), and mixtures thereof. Propylene glycol is particularly preferred. In a preferred aspect, the glycol is a recycled glycol, especially propylene glycol and recycled diethylene glycol. Propylene glycol recovered from used deicing fluids is one example. In another preferred aspect, the glycol is a recycled ethylene glycol, which may be recovered from used engine antifreeze or coolant.

Polycaprolactone Polyester Polyols

Polycaprolactone polyester polyols are also useful for the practice of this invention and may be blended with polyphenol alkoxylates to achieve inventive compositions. Polycaprolactone polyols are classified as polyester polyols. A review of this category of polyester polyols is provided in Chem. Soc. Rev., 2009, 38, 3484-3504.

Poly(Hydroxyl Alkyl Carboxylic Acid) Polyester Polyols

Poly(hydroxyl alkyl carboxylic acid) polyester polyols may be formed by simply heating a hydroxyl alkyl carboxylic acid such as 6-hydroxyhexanoic acid or ricinoleic acid in the presence of a glycol or to a temperature with stirring such that water is eliminated from the reaction.

Polyether Polyols

Polyether polyols, include for example polyalkylene oxides. For example, a polyether polyol is defined herein as the reaction product of propylene oxide, or ethylene oxide, or mixtures thereof with an initiator compound containing two or more active hydrogen atoms. The active hydrogen compound in the presence of a base catalyst initiates ring opening and oxide addition, which is continued until the desired molecular weight is obtained. Examples of active hydrogen compounds include glycerine, water, glycols (such as ethylene glycol, diethylene glycol, propylene glycol, and butylene glycol), trimethylol propane, ethylene diamine, pentaerythritol, sucrose, lactose, fructose, sorbitol, glucose, toluene diamine, diethanol amine, N-methyl diethanolamine, and triethanol amine.

In certain aspects of the practice of this invention, it is preferred that polyether polyols based on propylene oxide or random or block copolymers of propylene oxide with ethylene oxide have an OHV of greater than 75 mg KOH/g sample, more preferably greater than 150 mg KOH/g sample, and most preferably greater than 250 mg KOH/g.

In certain aspects of the practice of this invention, it is preferred that the polyether polyols according to the practice of this invention include poly(propylene oxide), poly(tetrahydrofuran), poly(butylene oxide) and poly(1,3-propanediol), more preferred that the polyether polyols according to the practice of this invention include poly(tetrahydrofuran), poly(butylene oxide) and poly(1,3-propanediol), and most preferred that the polyether polyols according to the practice of this invention include poly(butylene oxide).

The ability of a coating to protect a metal surface from corrosion, in part, depends upon the ability of that coating to provide low water absorption. Since the water absorption of a coating is dependent, in turn, upon the ability of the original polyol to absorb or dissolve water, in certain aspects of the practice of this invention it is preferred that the polyether polyols used in the practice of this invention have a solubility of water therein of less than 7.5%, more preferably less than 5.0% and most preferably less than 3% by weight.

Poly(1,3-propanediol) is produced by the polyetherification of 1,3-propanediol in the presence of a catalyst, optionally with comonomers. An example of the preparation of such polyether polyols is provided in US 20110152498, issued to DuPOnt. Ceranol™ is a trademarked family of polyether polyol liquid glycols manufactured and marketed by DuPont since 2008 using biorenewable 1,3-propanediol (PDO, CAS 504-63-2) as the basic feedstock. Cerenol grades include both homopolymers of PDO and copolymers using other conventional polyol feedstocks.

Polytetrahydrofuran is a polyether polyol prepared by cationic ring opening polymerization of tetrahydrofuran (THF). THF can be synthesized by catalytic hydrogenation of furan. Certain sugars can be converted to THF, although this method is not widely practiced. Furan is thus capable of being derived from renewable resources. Catalysts suitable for the polymerization of THF include trialkyloxonium salts, oxocarbenium salts, triflic esters, triflic anhydride, and fluorosulfonic acid.

### Polycarbonate Polyols

Polycarbonate polyols are those containing repeating units of aliphatic carbonic ester groups as shown below.

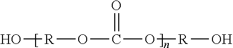

Such polyols may be prepared by reacting carbon dioxide with alkylene oxides such as propylene oxide in the presence of a catalyst such as those produced by Novomer (WO2010028362) under the trade name Converge™. These polyols may have hydroxyl functionalities of between about 2 to 6. Econic Technologies also produces polycarbonate polyols (WO2017037441).

Polycarbonate polyols may also be prepared by the reaction of diphenyl carbonate, phosgene, ethylene carbonate, or dialkyl carbonates with glycols. Perstorp produces such polycarbonate polyols under the trade name Oxymer™, while Covestro produces such polycarbonate polyols under the trade name Desmophen C™. Ube Industries produces polycarbonate polyols under the trade name Etemacoll™. Other polycarbonate polyols are described in WO2011129940, WO2017058504, U.S. Pat. Nos. 9,181,392 and 9,018,334).

### Polyester/Carbonate Polyols

Polyester/carbonate polyols, also called polycarbonate ester polyols, are usually produced by the transreaction between a polycarbonate polyol and a polyester polyol. Examples of polycarbonate ester polyols are described in WO02012135625A1 and US 20160053058.

### Polyether/Ester Polyols

Polyether/ester polyols are polyester polyols in which a polyether polyol has been used in lieu of glycol and other reactants during their manufacture to provide oligomeric polyether segments within the polyol.

Suitable polyether/ester polyols are well known and include aromatic and aliphatic polyester polyols. These polyols are terminated with hydroxyl groups and generally have low acid numbers (i.e., below 5 mg KOH/g). Suitable polyols are readily synthesized by condensation polymerization of dicarboxylic acids, esters, or anhydrides with low molecular weight diols, polyols, or their mixtures. Suitable dicarboxylic acids, esters, or anhydrides include, for example, phthalic anhydride, isophthalic acid, terephthalic acid, dimethyl terephthalate, trimellitic anhydride, maleic anhydride, succinic anhydride, succinic acid, dimethyl succinate, diethyl adipate, glutaric acid, adipic acid, sebacic acid, suberic acid, and the like, and combinations thereof. Suitable diols and polyols useful for making polyester polyols include, for example, ethylene glycol, propylene glycol, 2-methyl-1,3-propanediol, 1,4-butanediol, 1,6-hexanediol, diethylene glycol, dipropylene glycol, triethylene glycol, tripropylene glycol, neopentyl glycol, 1,4-cyclohexanedimethanol, glycerin, trimethylolpropane, trimethylolethane, pentaerythritol, and the like, and combinations thereof.

### Acrylic Polyols

Acrylic polyols are a group of amorphous polyols of molecular weights in the range of about 500 to 10,000 daltons, obtained by the radical copolymerization of acrylic monomers such as acrylic or methacrylic acids and esters. Other molecular weight 7 ranges include 750 to 8000, and 1000 to 5000. The source of hydroxyl groups in these polyols results from the incorporation of hydroxyalkyl acrylates or hydroxyalkyl methacrylates as co- or ter-monomers. The properties of polymers resulting from the reaction of these polyols with crosslinkers are controlled by the co- or ter-monomer selection and content. These polyols may be dispersed in water via the neutralization of acrylic acid or methacrylic acid comonomers with base. This class of polyols is further described in “Chemistry and Technology of Polyols for Polyurethanes” by Mihail lonescu, Rapra Technology Limited, 2005.

Poly(1,3-propanediol) and Poly(1,4-butanediol).

Poly(1,3-propanediol) is produced by the polyetherification of 1,3-propanediol in the presence of a catalyst, optionally with comonomers. An example of the preparation of such polyether polyols is provided in US 20110152498, issued to DuPont. Ceranol™ is a trademarked family of polyether polyol liquid glycols manufactured and marketed by DuPont since 2008 using biorenewable 1,3-propanediol (PDO, CAS 504-63-2) as the basic feedstock. PDO, in turn, is produced by DuPont entirely via corn sugar fermentation using genetically modified E. coli bacteria developed by DuPont in partnership with Tate & Lyle. Cerenol grades include both homopolymers of PDO and copolymers using other conventional polyol feedstocks. Cerenol has found commercial applications in automotive coatings, personal care products, thermoplastic elastomers, as a functional heat transfer fluid, and as an impact-resistant engineering plastic.

Also, useful herein is poly(1,4-butanediol).

### Oleochemical Polyols

Oleochemical polyols are also described as “natural oil polyols”, “seed oil polyols”, “vegetable oil polyols” and/or “biorenewable polyols”. Oleochemical polyols are based on seed oils of various types, including, but not limited to, soybean oil, sunflower oil, palm oil, rapeseed oil, olive oil, and canola oil. These seed oils are chemically modified via a number of approaches to provide two or more hydroxyl groups per molecule, thereby creating a polyol suitable for polymerization with crosslinkers. Further, the fatty acids or fatty acid esters of seed oils may be chemically modified to provide suitable oleochemical polyols. Examples of chemical modifications that are suitable for providing suitable oleochemical polyols from seed oils, seed oil fatty acids or esters include ozonolysis, hydrogenation, esterification, amidation, transesterification, epoxidation, alcoholysis, hydrolysis, hydrogenolysis, reaction with inorganic or organic acids, hydroformylation, metathesis, dimerization, Diels-Alder reaction, oxidation, and oxygen blowing.

An example of a seed oil that requires no chemical modification is castor oil, which, for the purposes of this invention is classified as an oleochemical polyol. Castor oil is a mixture of a triglyceride of mainly ricinoleic acid combined with lesser amounts of other fatty acids to provide a polyol having a hydroxyl functionality of about 2.7 hydroxyls per molecule and an OH value of approximately 160 mg KOH/g of sample. Castor oil may be chemically modified via transesterification, amidation, halogenation, and a variety of other chemical modifications to prepare other types of oleochemical polyols. Further, the fatty acids or fatty acid esters of castor oil may be chemically modified to provide suitable oleochemical polyols. Examples of oleochemical polyols that may be prepared from castor oil and its fatty acids or fatty acid esters include ethoxylated or propoxylated castor oil, hydrogenated castor oil, halogenated castor oil, and transesterified castor oil.

Hydroxy-functional materials derived from epoxidized, ozonized, or hydroformylated fatty esters, also commonly known as “bio-polyols” or “natural oil polyols” are another example of suitable oleochemical polyols. These products are typically made from natural oils in several steps. Some products include a step to epoxidize carbon-carbon double bonds in the natural oil, followed by a ring-opening step. In other products, unsaturation in the fatty ester is hydroformylated and then hydrogenated to introduce the hydroxyl functionality (see, e.g., D. Babb et al., Polym. Preprints 48 (2007) 855, PCT Internat. Appl. WO 2006/012344, and U.S. Pat. No. 8,598,297, the teachings of which are incorporated herein by reference). Polyols made by hydrolysis or alcoholysis of epoxidized soybean oil are among the suitable bio-polyols. BiOH® polyols supplied by Cargill (e.g., BiOH® X-0002) and Agrol® polyols from BioBased Technologies are also suitable. The bio-polyol can also be generated “in situ” from a reaction between the glycol and an epoxidized fatty ester (such as epoxidized soybean oil, epoxidized methyl oleate, or epoxidized methyl soyate). Suitable bio-polyols include polyols derived from ozonized fatty esters, such as mixtures obtained by ozonolysis of a natural oil in the presence of a glycol, as is described by P. Tran et al., J. Am. Oil Chem. Soc. 82 (2005) 653. For more examples of suitable oleochemical polyols, see U.S. Pat. Nos. 6,433,121; 8,664,352, U.S. Publ. Nos. 2012/0136169, 2011/0313124, and 2009/0287007, and PCT Appl. Nos. WO2009/058367, WO2009/140354, and WO2006/116456, the teachings of which are incorporated herein by reference.

### Polyaspartic Esters

Polyaspartic esters may be prepared from a wide variety of polyamines through the reaction of the amine substituents with dialkyl maleates or dialkyl fumarates. Structural variation in the amines provides viscosity and reactivity control towards polyisocyanates (U.S. Pat. Nos. 4,560,708, 5,580,945, 5,126,170, 6,458,293, 6,013,755, 5,243,012, US 20120225991, U.S. Pat. Nos. 4,874,837, and 6,005,062). The reaction between a polyaspartic ester and an isocyanate produces a polyurea. Covestro produces polyaspartic esters under the trade name Desmophen NH™.

### Polytetrahydrofuran Polyols (Polytetrahydrofurans (PolTHFs)

Polytetrahydrofuran is a polyether polyol prepared by cationic ring opening polymerization of tetrahydrofuran (THF). THF can be synthesized by catalytic hydrogenation of furan. Certain sugars can be converted to THF, although this method is not widely practiced. Furan is thus capable of being derived from renewable resources. Catalysts suitable for the polymerization of THF include trialkyloxonium salts, oxocarbenium salts, triflic esters, triflic anhydride, and fluorosulfonic acid. Poly(THF) is a specialty, high performance polyether polyol suitable for the practice of this invention. The polytetrahydrofurans can also include those having various substituents on the alkyl chains, and can be derived from substituted tetrahydrofurans.

### Crosslinkers

The coatings of the present invention are further made from crosslinker units. A crosslinker is a chemical moiety that links the chains of a polymer to one another.

The crosslinkers useful herein are selected from melamine crosslinkers, diisocyanate crosslinkers, diisocyanate trimer crosslinkers, and polyisocyanate crosslinkers.

### Melamine Crosslinkers

Melamine crosslinkers are also useful herein. Melamine is a trimer of cyanamide, with a 1,3,5-triazine skeleton and corresponds to the following structure.

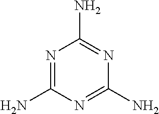

The compound hexakis(methoxymethyl)melamine (HMMM) and hexakis(hydroxymethyl) melamine are also useful crosslinkers.

Diisocyanate Crosslinkers

Diisocyanate crosslinkers are useful herein. Diisocyanates are chemical compounds having two reactive isocyanate moieties. In one aspect, diisocyanates such as hexamethylene diisocyanate can be employed herein. Other examples of diisocyanates include methylenebis(phenyl isocyanate) (MDI), polymeric methylene bis(phenyl isocyanate), toluene diisocyanate (TDI), and hexamethylene diisocyanate (HDI), naphthalene diisocyanate (NDI), methylene bis-cyclohexylisocyanate (HMDI), isophorone diisocyanate (IPDI), xylylene diisocyanate, hydrogenated xylylene diisocyanate, 2,2,4-trimethyl hexamethylene diisocyanate, 2,4,4-trimethyl hexamethylene diisocyanate and pentamethylene 1,5-diisocyanate. Derivatives of such diisocyanates may also be used, such as biurets, prepolymers, carbodiimides, and allophonates. Blocked isocyanate derivatives may also be utilized in the practice of the present invention. Examples of such blocked isocyanate derivatives include the reaction product of a di- or polyisocyanate with a thermally-labile blocking agent such as a phenol, caprolactam, benzotriazole, oximes, diisopropyl amine, t-butyl benzyl amine, and certain malonates. In another aspect of the present invention, the diisocyanate may be in the form of a trimer or isocyanurate. Such examples of trimers include hexamethylene diisocyanate trimer, 4,4′-methylene diphenyl diisocyanate trimer, isophorone diisocyanate trimer, and combinations thereof. A particular example of such a trimer is HDI isocyanurate trimer CAS #3779-63-3. Blends of these diisocyanates, derivatives thereof, and trimers thereof may be used. The diisocyanate crosslinked compositions should have an NCO/OH number ratio, or index, from about 0.75 to about 1.5. Another ratio is from 1.0 to 1.5. Another ratio is about 1.05. The NCO/OH number ratio or index refers to the isocyanate to hydroxyl number for the material.

### Corrosion Prevention Additives

In certain embodiments, the compositions can comprise a corrosion prevention additive. Examples of corrosion prevention additives include zinc phosphate (including modified zinc phosphate such as Heucophos ZPZ modified zinc phosphate), zinc chromate, Butrol 23, barium metaborate, calcium silica gel (such as, e.g., Shieldex Calcium Silica Gel), Cotrol 18-8 Amino Carboxylate, barium phosphosilicate (such as, e.g., HALOX BW-111 barium phosphosilicate), alumninum triphosphate (such as, e.g., K-White 105 aluminum triphosphate), and combinations thereof.

### Phenol Scavengers

In further embodiments, the compositions of the present invention optionally comprise a phenol scavenger, to help reduce levels of residual bisphenol and related compounds. The phenol scavenger is selected from carboxylic acids, dicarboxylic acids, alkylene oxides such as ethylene oxide and propylene oxide, glycidyl ethers, diglycidyl ethers, ethylene carbonate, propylene carbonate, and isocyanates, and combinations thereof.

Additionally, alkylene oxides such as ethylene oxide and propylene oxide can be used to cap or scavenge residual bisphenol-A. In such embodiments, an acid or base catalyst can be employed to facilitate the scavenging.

### Hydrophobes and Nonionic Surfactants

The compositions of this invention can also comprise hydrophobes, nonionic surfactants, and mixtures thereof. Hydrophobes include triglycerides and modified triglycerides, fatty acids, fatty acid esters, dimer fatty acids, fatty diacids, vegetable oils and modified vegetable oils (for example as described in U.S. Pat. Nos. 5,922,779, 6,359,022, 6,664,363, and WO 2013/154874A1); castor oil (for example, as described in WO 2013/154874A1); modified or derivatized polyterpenes; modified cashew nut shell oil; cardanol; derivatives of cardanol; Diels Alder or ene reaction modified polyols (for example, as described in WO 2013/109834); and tall oil fatty acids (for example, as described in U.S. Pat. Nos. 5,075,417 and 4,897,429). The aromatic polyester polyols may further comprise nonionic surfactants or reactants (for example, as described in U.S. Pat. No. 4,529,744, WO 9919377 and WO 2009045926). All of which are cited in this paragraph are incorporated by reference herein in their entirety.

Examples of triglycerides suitable for the practice of this invention include soybean oil, animal tallow, fish oil, canola oil, castor oil, tung oil, linseed oil, corn oil, recycled cooking oil, sunflower oil, palm oil, peanut oil, palm kernel oil, cottonseed oil, coconut oil, and safflower oil.

Examples of fatty acids suitable for the practice of this invention include linoleic, myristic, palmitic, caproic, caprylic, capric, 2-ethyl hexanoic, lauric, stearic, oleic, linolenic, ricinoleic, tall oil, and mixtures thereof. The alkyl esters of these fatty acids and mixtures of these alkyl esters thereof are also suitable examples for the practice of this invention.

Examples of fatty diacids suitable for the practice of this invention include azelaic acid; sebacic acid; dodecanedioic acid; tetradecanedioic acid; hexadecanedioic acid; octadecanedioic acid; nonene dioic acid; decenedioic acid, dodecenedioic acid; tetradecenedioic acid; hexadecenedioic acid; octadecenedioic acid; eicosendioic acid; eicosandioic acid; docosandioic acid; tetracosandioic acid; tetracosendioic acid; and the like and mixtures thereof.

Examples of nonionic surfactants include block copolymers of ethylene oxide with either propylene oxide, butylene oxide, or mixtures of propylene oxide with butylene oxide. See “nonionic Surfactants: Polyoxyalkylene Block Copolymers”, (Surfactant Science Series, Book 60, CRC Press), 1996, Vaughn Nace, ed. and “Nonionic Surfactants: Organic Chemistry” (Surfactant Science Series Book 72), 1997 Nico M. van Os., ed., which are incorporated by reference herein in their entirety. It is well known that initiators are used to initiate such block copolymers. Suitable initiators include glycols; monols; fatty alcohols; alkyl phenols; phenol; styrenated phenols; bisphenols; triols; and tetrols. An additional nonionic surfactant suitable for use as a reactant or additive includes ethoxylated or alkoxylated castor oil.

### Blends

As stated above, the term “blend” as used herein relates to a physical mixture of two or more substances to a homogeneous state, such that they do not subsequently or appreciably separate.

The blends should have a viscosity from about 500 cP to about 50,000 cP at about 25° C., so that they are readily handled, particularly at room temperature. Another useful viscosity range is below about 35,000 cP at about 25° C., or less than about from about 15,000 cP at about 25° C., or less than about 10,000 cP at about 25° C.

The blend should be substantially free of polyphenol contaminant. If the bisphenol alkoxylate is a bisphenol-A alkoxylate, the blend should be substantially no of bisphenol-A contaminant, and thus have a content of less than about 1000 ppm by weight, and in other instances of less than about 250 ppm by weight.

Because the blends have a relatively low, desirable viscosity they have the advantage of providing this low viscosity with the need for thinning solvents, and are likely to have a low VOC content. The blends of the present invention in some embodiments have a low VOC emission such that the VOC content is less than about 250 g/L. In other embodiments, the VOC content is less than about 100 g/L. In other embodiments, the VOC content is less than about 50 g/L.

Blends of Polyester Polyols with BPA Alkoxylates Via Reactive Process:

One approach for providing a blend composition according to the practice of this invention is to take a previously prepared polyester polyol and a previously prepared bisphenol alkoxylate and simply mix them together to achieve a compatible blend. However, the disadvantage of this approach is that bisphenol alkoxylates that are based on recycled or biorenewable content are not commercially available. Therefore, it is desirable to have an approach for achieving these blends in a manner such that a high sustainable content polyol blend is achieved. This problem is solved via the use of a reactive process. In this blend-forming process, a thermoplastic polyester is glycolyzed to provide a polyester polyol intermediate, followed by the glycolysis of a thermoplastic poly(bisphenol carbonate) such as poly(bisphenol A carbonate) using the polyester polyol intermediate to form a co-glycolyzed intermediate. Unfortunately, this approach forms free bisphenol, an undesirable side product from environmental, safety and health standpoint, especially where bisphenol-A is concerned. The benefit of this approach is that recycled thermoplastic polyester and recycled thermoplastic poly(bisphenol carbonate) may be used, yielding an improvement in the sustainable content of the resulting polyol.

The co-glycolyzed intermediate may be formed by

(a) Glycolyzing the thermoplastic polyester first, followed by glycolysis of the thermoplastic poly(bisphenol carbonate); or

(b) Concurrently glycolyzing both the thermoplastic polyester and the thermoplastic poly(bisphenol carbonate) at the same time; or

(c) Glycolyzing the thermoplastic poly(bisphenol carbonate) first, followed by glycolysis of the thermoplastic polyester; or

(d) Glycolyzing the thermoplastic polyester in the presence of both glycol and bisphenol to provide a glycolyzed thermoplastic polyester polyol with free bisphenol content; or

(e) Glycolyzing the thermoplastic polyester in a first reactor. Glycolyzing the thermoplastic poly(bisphenol carbonate) separately in a second reactor, followed by a scavenging reaction to minimize the amount of free bisphenol produced. This alternative two-reactor procedure has the advantage of reducing the amount of material to be scavenged versus performing the scavenging step on the combined reaction. The reaction products from the first and second reactor can be combined to provide a blend for further processing; or

(f) Glycolyzing a thermoplastic poly(bisphenol carbonate) using a single glycol, such as diethylene glycol, whereby the target molecular weight of the glycolysis product is achieved by adjusting the ratio of moles of the repeat polycarbonate units to the moles of glycol. The glycolysis reaction is run until the contents are homogeneous and there is no undigested polycarbonate. The glycolysis product can optionally be subsequently subjected to a scavenging reaction to minimize the amount of free bisphenol produced by directly forming the bisphenol alkoxylate. The final free bisphenol level is preferably at a concentration of less than 5%, more preferably less than 3%, and most preferably 1% or less, by weight, in a mixture with the polycarbonate oligomeric product. The polycarbonate oligomeric product preferably has a molecular weight range of 350-700 daltons. These mixtures, containing both the alkoxylated bisphenol and the low molecular weight polycarbonate-glycol oligomer, or alternatively, containing a low free bisphenol level without alkoxylation and the low molecular weight polycarbonate-glycol oligomer, can be used as a “stand alone” additive that can be blended into an existing polyol to enhance the corrosion performance of the polyol.

We have found that approach (a) often yields faster glycolysis than either (b) or (c), and therefore this approach is generally preferred in terms of improving overall reactor efficiency. In option (d) the glycol and bisphenol are added simultaneously. The problem for any of these options (a) through (d) is that undesirable bisphenol is formed as a side product. Approach (e) therefore has the advantage of minimizing undesired bisphenol and also provides better molecular weight control of the final product when further reacted with, e.g. a diacid. Approach (f) also minimizes the undesired bisphenol and provides an “additive” which can be blended into a polyol to enhance its performance.

As a means of scavenging undesirable side product or free bisphenol produced, the co-glycolyzed intermediate may be treated with a modifier selected from propylene carbonate, ethylene carbonate, propylene oxide, ethylene oxide, an aliphatic C2-C12 carboxylic acid, a glycidyl ether, a diglycidyl ether, a C4-C36 aliphatic or cycloaliphatic dicarboxylic acid or mixtures thereof. These modifiers, when further reacted into the reaction mixture, permit the reduction of undesirable bisphenol a side product, while at the same time forming desirable bisphenol alkoxylates and esters, which result in polyester polyol blends useful for the practice of this invention.

According to one reference (Lin, C-H, Lin, H-Y, Liao, W-Z, Dai, S., Green Chem., 2007, 9, 38-43), poly(bisphenol A carbonate) may be completely glycolyzed and purified to form relatively high levels bisphenol A. Their resulting bisphenol A product was then alkoxylated using propylene glycol/urea mixtures. We have found that the complete glycolysis of poly(bisphenol A carbonate) is undesirable from a coatings property standpoint, as it is more desirable to leave oligomeric polycarbonate polyols available in the mixture to yield improved physical properties. Additionally, it is undesirable to conduct a complete glycolysis of poly(bisphenol carbonate) due to the desire to maximize reactor efficiency, which is reduced during the loss of carbon dioxide from the reaction between propylene carbonate and bisphenol. Therefore, it is desired to minimize the use of alkylene carbonate (formed as an intermediate during the Lin process from propylene glycol and urea or ethylene glycol and urea).

During the process for producing blends via a reactive process, it may be desirable to use a catalyst such as a catalyst selected from a titanium-based catalyst, a tin-based catalyst, an inorganic metal carbonate or bicarbonate salt, sodium hydroxide, a tertiary amine, potassium hydroxide and mixtures thereof at a level less than about 0.25% by weight in the overall polyol.

### Coatings

The polyol blends of the present invention are useful for making coatings. A coating is a covering that is applied to the surface of an object, which usually referred to as the substrate. The coatings typically comprise from about 1% to about 95%, by weight of the polyester polyol, preferably from about 2% to about 90% by weight of the polyester polyol, and more preferably from about 5% to about 80% by weight of the polyester polyol. The optimum weight percentage of the polyester polyol can be determined by one of skill in the art to obtain the desired property of the coating both before and after application to the substrate. Both liquid coatings and powder coatings can be made with the polyols of the present invention. Examples of liquid coatings include polyurethane coatings. These liquid coatings can include additional components such as catalysts, flow and leveling agents, surface modifying additives, wetting agents, dispersing agents, foam-control agents, solvents, crosslinking additives, co-blended resins to modify properties, pigments and colorants, and degassing agents.

Powder coatings provide an important alternative to liquid coatings. These coatings can be prepared from resins, pigments, and additives. The powder is applied to a substrate, usually metal, and fused to form a continuous film by baking the coated metal, or by applying the powder coating to a heated substrate. The powder coatings typically have a glass transition temperature, Tg, greater than or equal to 45° C., preferably greater than or equal to 50° C., and more preferably greater than or equal to 55° C. The powder coatings also typically have a melting point greater than or equal to 45° C., preferably greater than or equal to 50° C., and more preferably greater than or equal to 55° C. The glass transition temperature and the melting point of the powder coating can be adjusted by the selection of the polyester polyol or polyols incorporated, as well as the weight percentage of the polyol or polyols in the coating. It is highly desirable to adjust the glass transition temperature and melting point such that the powder coating remains as a free flowing powder at room temperature and elevated storage conditions, such as for example in a hot warehouse, but also readily melts to form a uniform coating on a substrate that has either been preheated before application of the powder coating or that is subsequently baked after application of the powder coating. While it is important to maintain a high enough glass transition temperature and melt temperature to prevent sintering, it is desirable to simultaneously tune the powder coating such that the optimal melt flow and crosslinking temperature is as low as possible, which results in a lower, narrower process window for films. This lower temperature is advantageous from an energy savings standpoint to the applicator. Additives are an important ingredient in the formulation of powder coatings. For the most part, additives perform the same functions in powder coatings as in liquid coatings. With the exception of wetting, dispersing and foam-control agents, many of the same additives used in liquid coatings are also used in powders. The powder coatings can comprise additional components such as crosslinking agents, flow control agents, degassing agents, catalysts, and pigmenting materials. The powder coatings can be applied to a metal substrate using conventional techniques known in the art such as electrostatic spraying. The metal substrate can either be preheated before application of the powder coating or baked after the application of the powder coating to thermally set the coating.

The liquid coatings of the present invention can be either 1K or 2K coatings. Examples of liquid coatings include polyurethane coatings.

The liquid coatings can include additional components such as catalysts, flow and leveling agents, surface modifying additives, wetting agents, dispersing agents, foam-control agents, solvents, crosslinking additives, co-blended resins to modify properties, pigments and colorants, and degassing agents.

The term 1K coating is used to describe a coating that does not require a hardener, catalyst, or activator. The term is also used to describe single component paints that dry in the air, examples of which include latex house paint, traditional lacquer, and aerosol spray can paints.

The term 2K coating is used to describe a coating that is mixed with a hardener, catalyst, or activator. Generally, such coatings are more durable than 1 K coatings and less susceptible to damage. With 2K coatings, the activator is kept in a separate compartment or container and is mixed with the coating prior to or during application.

See U.S. Pat. No. 5,637,654, to Panandiker et al, issued Jun. 10, 1997; U.S. Pat. No. 4,197,353, to Tobias et al, issued Apr. 8, 1980; PCT Patent Application No. WO 2011/138432 A1, to DSM IP Assets, B. V., published Nov. 10, 2011; and “Organic Coatings Science and Technology”, 3rd Ed., Wiley, 2007, Z. Wicks, Jr., F. Jones, S. P. Pappas, D. A. Wicks, Chapter 28, which are incorporated by reference herein in their entirety.

Floor Coatings

Applications for the polyol blends also include polyurethane floor coatings for gymnasium and other athletic wooden floors, polyurethane coatings for pre-manufactured linoleum, vinyl floors, and wooden floors, and primed concrete floors such as those found in garages, warehouses, manufacturing facilities and other indoor facilities. We have found, for example, that blends of castor oil with alkoxylates of bisphenol-A are particularly suitable for use as sustainable floor coatings in these types of applications.

Floor coatings also require different final product physical characteristics versus other types of coatings. For example, floor coatings should provide an appropriate level of friction, and thus have a sufficiently high coefficient of friction so that the resultant surface is not slippery or provides a slipping hazard for uses. Embodiments of the present invention should not contain phthalate based plasticizers, as these plasticizers could tend to make the floor coating slippery due to release or weeping of the plasticizer material. Floor slip resistance testing involves measuring the coefficient of friction, or resistance to slip accidents. For example, the safety standards of the American National Standards Institute (ANSI) specifies for a level floor using the B101.3 dynamic test method that a flooring having a minimum dynamic coefficient of friction (DCOF) of 0.43, which corresponds to “high slip resistance”. Other minimum dynamic coefficients of friction are 0.30, 0.35, 0.40, 0.45, 0.50, 0.55, 0.60, and 0.65.

In another aspect, the present invention relates to a coated floor surface wherein the resulting coating provides a static coefficient of friction of 0.5 or greater as measured by ASTM C1028.

Non-Isocyanate Polyurethanes (NIPUs) Prepared from the Poly Blends

Conventional polyurethanes are typically obtained from polyisocyanates (e.g. diisocyanates), polyols (e.g., polyesters or polyethers), and also from chain extenders. The isocyanate starting materials used in the conventional processes can raise health and environmental concerns. Thus, there is a potential need to move away from the use of isocyanates in preparing polyurethanes. See, Rokicki, G. et al., “Non-isocyante polyurethanes: synthesis, properties, and applications”. Polym Adv. Technol, 26, 707-761 (2015), which is incorporated by reference herein it is entirety.

The polyol blends of the present invention can be used to prepare substantially isocyanate-free polyurethanes, i.e. non-isocyante polyurethanes (NIPUs).

Non-isocyanate polyurethanes (NIPUs) may be prepared via the polycondensation of dialkyl carbamates and diols or polyols (Scheme 1). These and other routes to NIPUs using diols and polyols have been reviewed by Janusz Datta and Marcin Wloch in Polymer Bulletin (2016) 73:1459-1496, hereby incorporated in its entirety by reference.

The following scheme is an example of an NIPUs via the polycondensation of dialkylcarbamates and diols.

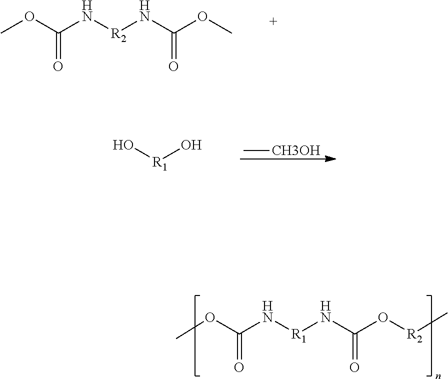

Another route has been commercialized by the Dow Chemical Company as described in U.S. Pat. Nos. 9,006,379; 8,653,174 and PARALOID™ EDGE 2121 Resin Solvent Borne Alkyd Carbamate product brochure, published as Dow Chemical Company document number 884-00828-0715-NAR-EN-BDC, all hereby incorporated by reference herein in their entirety. This route involves the reaction of a di- or poly-carbamate with a di- or polyaldehyde, as shown in the following scheme, whereby the di- or poly-carbamate can be prepared by the reaction of a diol or polyol with urea or an alkyl carbamate.

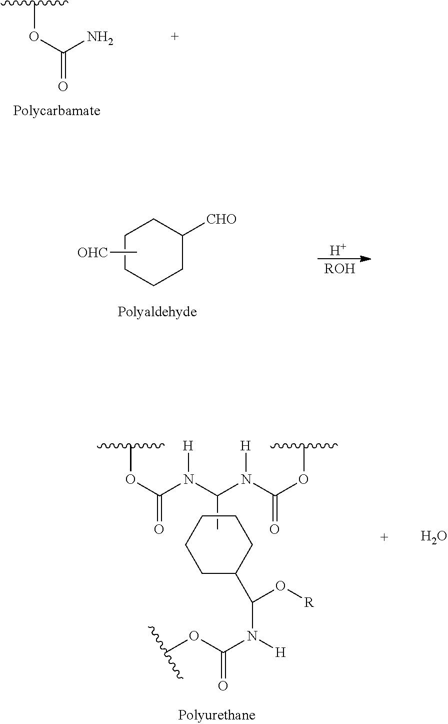

Alternatively, a di- or polyol may be converted into an isocyanate prepolymer by reaction with a polyisocyanate and then further reacted with hydroxethyl carbamate to form a di- or poly-carbamate. This resulting polycarbamate may be reacted with a polyaldehyde to provide a NIPU. Although this latter route uses a polyisocyanate, it does not require a polyurethane manufacturer to purchase a polyisocyanate, instead the end user would purchase only a polycarbamate resin and a polyaldehyde. This route thereby avoids exposure of the end user to relatively toxic polyisocyanates. Since this route avoids the need for a polyisocyanate by the end user, we include this route to forming a polyurethane under the definition of a “substantially isocyanate-free polyurethane”.

Other Considerations

In other embodiments of the present invention for polyurethane dispersions, the compositions should be substantially free of melamine and diisocyanates.

In other embodiments of the present invention the compositions should be substantially free of naphthalene dicarboxylic acids when glycols such as 2,2-dialkyl-1,3-propanediol.

In other embodiments of the present invention, the compositions should be substantially free of halogenated alkoxylated polyphenols.

In other embodiments of the present invention, the compositions should be substantially free of pyridine-based amines, such as bis(2,2,6,6-tetramethyl-4-piperidyl)sebacate.

Processes, Properties and Compositions

The present invention provides a means for incorporating recycled materials, particularly polyacid sources, to provide a polyol blend having a high recycle content. The recycle content of the resultant polyester polyol of such blends can have a wide range of recycle content, but those having a recycle content of about 50% by weight or more would be particularly attractive.

For example, the thermoplastic polyester and glycol are heated, optionally in the presence of a catalyst, to give a digested intermediate. The digested intermediate will commonly be a mixture of glycol reactant, glycol(s) generated from the thermoplastic polyester, terephthalate oligomers, and other glycolysis products. For example, when PET or rPET is the thermoplastic polyester, the digested intermediate will include a mixture of glycol reactant, ethylene glycol (generated from the PET or rPET), bis(2-hydroxyalkyl) terephthalate (“BHAT”), higher PET oligomers, and other glycolysis products. Similar digested mixtures in various forms have been made and characterized previously (see, e.g., D. Paszun et al., Ind. Eng. Chem. Res. 36 (1997) 1373 and N. Ikladious, J. Elast. Plast. 32 (2000) 140, which are incorporated by reference herein in their entirety). Heating is advantageously performed at temperatures within the range of 80° C. to 260° C., preferably 130° C. to 240° C., more preferably 150° C. to 230° C., and most preferably 160° C. to 220° C.

More specifically, in the context of the present invention, glycolysis refers to the reaction of the hydroxyl group of a digested aromatic polyacid source, e.g., a thermoplastic polyester intermediate with a digestible polymer in a manner to reduce the molecular weight of the digestible polymer thereby providing a polyol that is liquid at temperatures between 20° C. and 120° C.

In one aspect, when the thermoplastic polyester is polyethylene terephthalate, the digested intermediate comprises a glycol or mixture of glycols and a terephthalate component. The glycols and terephthalate components must be digested via a transesterification reaction and this digestion reaction is performed by heating the thermoplastic polyester, glycol(s), and any catalyst at least until the mixture liquefies and particles of the thermoplastic polyester are no longer apparent at the temperature of reaction. Reaction times range from about 30 minutes to about 16 hours, more typically 1 to 10 hours, even more typically 3 to 8 hours, and will depend on the reaction temperature, source of the thermoplastic polyester, the particular glycol reactant used, mixing rate, desired degree of depolymerization, and other factors that are within the skilled person's discretion.

The molar ratio of glycol to aromatic polyacid source is at least 0.8, preferably 2.0 to 6.0, more preferably 2.5 to 4.5. When the glycol/aromatic polyester source molar ratio is below about 2.0, the products are often solids at room temperature or too viscous to be practical for use as conventional polyols for polyurethane applications, however, for the purpose of digesting digestible polymers at elevated temperatures, glycol to thermoplastic polyester ratios between 0.8 and 2.0 are acceptable. On the other hand, when the glycol/aromatic polyester source molar ratio is greater than about 6, the hydroxyl numbers of the resulting digested digestible polymer-based polyols tend to exceed the practical upper limit of about 800 mg KOH/g.

In a second reaction step, the digested intermediate described above is reacted with a digestible polymer to give the inventive polyester polyol.

The reaction between the digested intermediate and the digestible polymer is performed under conditions effective to promote reaction between one or more functional groups of the digestible polymer and hydroxyl groups present in the digested intermediate.

The weight percent of digestible polymer in the resulting polyester product after digestion is from 1% to 75%, preferably from 3% to 60%, most preferably from about 5% to about 45%.

As long as some digestible polymer is used to make the polyol, one or more other digestible polymers can also be included. Mixtures of digestible polymers can be used.

In another aspect, the polyester polyol is made in a single step, or one pot reaction, by reacting the aromatic polyacid source, glycol, and digestible polymer under conditions effective to produce the polyol. As with polyols made using the two-step process, the weight percent of digestible polymer in the resulting polyester product after digestion is from 1% to 75%, preferably from 3% to 60%, most preferably from 5% to 45%, the molar ratio of glycol to aromatic polyester source is at least 0.8, and the resulting polyol has a hydroxyl number within the range of 10 to 800 mg KOH/g. When the single-step process is used, it is preferred to utilize a condensation system that returns glycols to the reaction vessel while allowing removal of water, as removal of too much glycol can result in cloudy or opaque polyols.

The inventive polyester polyols have hydroxyl numbers within the range of 10 to 800 mg KOH/g, preferably 25 to 500 mg KOH/g, more preferably 35 to 400 mg KOH/g, and even more preferably 50 to 400 mg KOH/g. Hydroxyl number can be measured by any accepted method for such a determination, including, e.g., ASTM E-222 (“Standard Test Methods for Hydroxyl Groups Using Acetic Anhydride Acetylation”).

The inventive polyols preferably have average hydroxyl functionalities (i.e., the average number of —OH groups per molecule) within the range of 1.5 to 5.0, more preferably 1.8 to 4.5, and most preferably 2.0 to 4.0.

The inventive polyols are flowable liquids at temperatures between 20° C. and 125° C. Preferably, the polyols have viscosities measured at between 25° C. and 125° C. of less than about 20,000 cP. In some embodiments, the polyols have a viscosity at 25° C. less than about 20,000 cP. In other embodiments, the polyols have a viscosity at 25° C. less than about 10,000 cP. In yet other embodiments, the polyols have a viscosity at 125° C. less than about 5000 cP. However, polyols outside these viscosity ranges can also be useful.

Viscosity can be determined by any industry-accepted method. It is convenient to use, for instance, a Brookfield viscometer (such as a Brookfield DV-III Ultra rheometer) fitted with an appropriate spindle, and to measure a sample at several different torque settings to ensure an adequate confidence level in the measurements.

The polyols preferably have low acid numbers. Urethane manufacturers will often require that a polyol have an acid number below a particular specification. Low acid numbers can be ensured by driving the condensation step (with digestible polymer) to the desired level of completion or by adding an acid scavenger (e.g., Cardura™ E10P glycidyl ester manufactured by Momentive) at the conclusion of the condensation step. Preferably, the polyols have an acid number less than 30 mg KOH/g, more preferably less than 10 mg KOH/g, and most preferably less than 5 mg KOH/g. As suggested above, it is acceptable practice to adjust acid numbers if necessary for a particular application with an acid scavenger such as, for example, an epoxide derivative, and this treatment can be performed by the manufacturer, distributor, or end user.

In the case of polyester polyols prepared using PU or PIR digestible polymers, small amounts of toluene diamine (TDA), methylene diphenyl amine (MDA) or polymeric methylene diphenyl amine (PMDA) may be formed. As these substances are hazardous materials, it is desirable to reduce or eliminate their presence in the resulting polyester polyols. It is believed that this may be accomplished by introducing small amounts of an amine scavenger such as, for example, an alkylene oxide, a glycidyl ether, an epoxy-derivative such as epoxidized soybean oil, an isocyanate or polyisocyanate derivative into the resulting polyester polyol concurrent with heating and stirring to achieve reaction between the TDA, PMDA or MDA an the amine scavenger, thereby reducing the content of these hazardous substances in the polyester polyols derived from PU and PIR digestible polymers.

An advantage of the polyol blends is their reduced reliance on bio- or petrochemical sources for raw material. Preferably, the polyols include greater than 10 wt. %, more preferably greater than 25 wt. %, most preferably greater than 50 wt. % of recycle content. A preferred range for the recycle content is 25 to 99.9 wt. %. By “recycle content,” we mean the combined amounts of recycled thermoplastic polyester and any recycled glycol or digestible polymer. Some glycols, such as propylene glycol or ethylene glycol, are available as recovered or recycled materials. For instance, propylene glycol is used in deicing fluids, and after use, it can be recovered, purified, and reused. Additionally, recycled ethylene glycol may be obtained from recovered engine antifreeze or engine coolant. Preferably, the digestible polymer is prepared or obtained from renewable resources or post-consumer or post-industrial recycled sources. Recycle content can be calculated, for instance, by combining the masses of recycled thermoplastic polyester and any recycled glycol or recycled digestible polymer, dividing this sum by the total mass of reactants (glycols, thermoplastic polyester, and digestible polymer), and then multiplying the result by 100.

A desirable polyol attribute is the absence of settling, particularly upon prolonged storage. When settling is substantial, the polyol might have to be filtered, stirred, stirred with heating or otherwise treated to remove or redissolve the solids content; this is preferably avoided. Preferred inventive polyols exhibit no settling or only a slight degree of settling, and more preferred polyols exhibit no evidence of settling.

In a specific aspect, the invention relates to a process which comprises: (a) heating virgin PET, recycled PET, or a mixture thereof with propylene glycol in the presence of a zinc or titanium catalyst to give a digested intermediate; and (b) condensing the intermediate with a digestible polymer to give the polyester polyol; wherein the weight percent of digestible polymer in the resulting polyester product after digestion is from 1% to 75%, preferably from 3% to 60%, most preferably from about 5% to about 45%., the molar ratio of glycol to PET is within the range of 2.5 to 4.5, and the polyol has a hydroxyl number within the range of 25 to 500 mg KOH/g, a viscosity less than 20,000 cP between 25° C. and 90° C., and a recycle content as defined herein greater than 25 wt. %.

### Examples

The following examples further describe and demonstrate embodiments within the scope of the present invention. The Examples are given solely for purpose of illustration and are not to be construed as limitations of the present invention, as many variations thereof are possible without departing from the spirit and scope of the invention.

“Recycle content” as used herein (wt. %) is determined by combining the masses of recycled glycol, recycled aromatic polyacid source, recycled hydrophobe, and recycled digestible polymer, and dividing this sum by the total mass of reactants, and then multiplying the result by 100.

Hydroxyl numbers and acid numbers are determined by standard methods (ASTM E-222 and ASTM D3339, respectively). Viscosities are measured at 25° C. using a Brookfield DV-III Ultra rheometer with spindle #31 at 25%, 50%, and 75% torque, with 50% torque being the usual torque setting. Alternatively, depending on the viscosity of the sample, viscosities can also be measured at other temperatures, including up to about 50° C. or higher. Also, viscosities can be determined on diluted samples. Color, clarity, and degree of settling are evaluated visually.

Coating durability is evaluated by 500 hour salt spray resistance of a coated substrate as described herein. Coating durability is also evaluated as per one or more of the following ASTM testing standards: ASTM B117, ASTM D714, ASTM D610, or ASTM D1654. The coating of the present invention can be evaluated against a control coating prepared without poly(bisphenol-A carbonate) or recycled poly(bisphenol-A carbonate).

### Example 1. Preparation of a Polyol and Further Conversion to a Polyphenol Alkoxylate

The following is a general procedure for preparing the polyol component of the polybisphenol alkoxylate blend.

A four neck reactor equipped with an overhead mixer, condenser (set at 10° C.), heating mantle, thermocouple and nitrogen inlet is charged with rPET, propylene glycol, neopentyl glycol, glycerol and monobutyltin oxide (MBTO). The reaction temperature is set to 200° C., nitrogen set to ˜0.2 SCFH with low (˜55 RPM) mixing. Mixing is increased as the mixture decreases in viscosity and homogenizes as temperature increases, typically by 160° C. the mixing is increased to ˜200 RPM. The reaction is held at 200° C. until no suspended pieces of rPET remain. If rPET is adhered to the side of the reactor the mixing is increased to wash in these particles. The reaction is allowed to continue at 200° C. until the glycolysis is complete determined by the naked eye seeing no visual evidence of rPET pieces in solution. At this point the trans-esterification is complete and the temperature is reduced to 100° C. for the second step in the reaction process.

Once the reactor contents has decreased to <100° C., the condenser is swapped for a 5-stage vacuum separation column, above that a short-path distillation head with overhead temperature probe and receiving flask. Succinic acid, isophthalic acid and Syn Fac 8009 is added and the temperature is set to 150° C., nitrogen increased to ˜0.6-1.0 SCFH (SynFac 8031 and 8385 are also added to separate batches at an equal molar amount as 8009 for a total of three different batches each containing a different BPA alkoxylate). Mixing is increased to ˜225 RPM and temperature of the batch is increased by monitoring the head temp above the separation column. Once the head temp drops below 90° C. the reaction temperature is set 10° C. higher. This step-wise temperature increase is continued until the batch reaches 200° C. Once at 200° C. the batch is held for four hours then dropped to 180° C. for overnight reaction. The next day a sample is pulled for acidity, if the value is <10 but >5 the batch is deemed complete and temperature is set to 120° C. If the acid value is >10 the reaction is allowed to continue and samples for acid value are taken every 2 hours until the acid value is <10. Once the reaction contents reaches 120° C. the separation column is again replaced with the condenser (set at 10° C.) for solvent let down. N-butyl acetate is added to achieve 80% solids, and the reaction is held at 120° C. for 1 hour to complete the let down. Once this is complete the polyol is cooled to less than 100° C. and poured out.

### Example 2. Polyols for Coatings

We designed and made the following polyester polyol (IMP1000-6.5 G) using the procedure of Example 2.

Polyester Polyol Batch

| | XIMP1000-6.5 |
|---|---|
| rPET | 38.80 |
| neopentyl glycol | 16.39 |
| propylene glycol | 9.70 |
| glycerol | 1.75 |
| isophthalic acid | 8.68 |
| succinic acid | 24.54 |
| Monobutyltin oxide catalyst | 0.145 |
| Total | 100 |
| Green content = recycle content + | 73.04 |
| renewable content | |

Values in weight percent

### Example 3. Coatings Containing Bisphenol-A Alkoxylates

The following coating compositions (Samples 1 to 6) were prepared from the polyester polyol from Example 2 (IMP1000-6.5 G) and the indicated commercially available polyphenol alkoxylate available from Milliken & Company, Milliken Chemical, Spartanburg, S.C. 29303. These polyphenol alkoxylates included:

SynFac 8009—an Ethoxylated Bisphenol-A

Reported to have a MW of 492, a hydroxyl number of 228 (mg KOH/g), and an undiluted viscosity of 2320 cps.

SynFac 8031—an Ethoxylated/Propoxylated Bisphenol-A

Reported to have a MW of 548, a hydroxyl number of 204 (mg KOH/g), and an undiluted viscosity of 4315 cps.

SynFac 8385—a Propoxylated Bisphenol-A

Reported to have a MW of 402, a hydroxyl number of 279 (mg KOH/g), and an undiluted viscosity of 40,000 cps.

The coatings, which were intended for industrial direct-to-metal (DTM) applications, were cured using a 2K high temperature bake over a metal substrate. Coating performance data is provided in Tables 1 to 3. It is seen that the compositions are useful as coatings.

Compositions of Coating Compositions

Sample 1: 70:30 IMP1000-6.5 G to SynFac 8009, an ethoxylated bisphenol-A.

Sample 2: 80:20 IMP1000-6.5 G to SynFac 8009, an ethoxylated bisphenol-A.

Sample 3: 70:30 IMP1000-6.5 G to SynFac 8031, an ethoxylated/propoxylated bisphenol-A.

Sample 4: 80:20 IMP1000-6.5 G to SynFac 8031, an ethoxylated/propoxylated bisphenol-A.

Sample 5: 70:30 IMP1000-6.5 G to SynFac 8385, a propoxylated bisphenol-A.

Sample 6: 80:20 IMP1000-6.5 G to SynFac 8385, a propoxylated bisphenol-A.

Sample 7: IMP1000-6.5 no additives (control)

TABLE 1
Dry Film Thickness

| | | | Dry Film Thickness (mils) | | | | |
|---|---|---|---|---|---|---|---|
| | | Panel | | | | | Std. |
| Sample | Substrate | No. | Top | Middle | Bottom | Average | Dev. |
| 1 | Cold | 1 | 1.85 | 1.95 | 1.71 | 1.84 | 0.12 |
| | Rolled | 2 | 1.72 | 2.17 | 2.06 | 1.98 | 0.23 |
| | Steel | | | | | | |
| 2 | Cold | 1 | 1.94 | 1.94 | 1.78 | 1.89 | 0.09 |
| | Rolled | 2 | 1.91 | 1.92 | 1.89 | 1.91 | 0.02 |
| | Steel | | | | | | |
| 3 | Cold | 1 | 2.04 | 2.02 | 2.00 | 2.02 | 0.02 |
| | Rolled | 2 | 1.99 | 2.05 | 2.02 | 2.02 | 0.03 |
| | Steel | | | | | | |
| 4 | Cold | 1 | 1.94 | 1.89 | 1.89 | 1.91 | 0.03 |
| | Rolled | 2 | 1.84 | 1.83 | 1.83 | 1.83 | 0.01 |
| | Steel | | | | | | |
| 5 | Cold | 1 | 1.94 | 2.08 | 1.89 | 1.97 | 0.10 |
| | Rolled | 2 | 1.97 | 1.93 | 1.94 | 1.95 | 0.02 |
| | Steel | | | | | | |
| 6 | Cold | 1 | 1.83 | 2.14 | 1.95 | 1.97 | 0.16 |
| | Rolled | 2 | 1.93 | 1.96 | 1.93 | 1.94 | 0.02 |
| | Steel | | | | | | |
| 7 | Cold | 1 | 2.09 | 3.59 | 1.91 | 2.53 | 0.92 |
| | Rolled | 2 | 1.88 | 1.90 | 1.82 | 1.87 | 0.04 |
| | Steel | | | | | | |

TABLE 2
Test Results after 498 Hour Salt Spray Exposure

| | | | | | Scribe | | |
|---|---|---|---|---|---|---|---|
| | | Panel | | | Creep | Scribe | |
| Sample | Substrate | No. | Blistering | Field | (mm) | Rating | Comments |
| 1 | Cold Rolled | 1 | 10 | 7S & | 0.5-1.0 | 8.0 | 20+ mm blister halo |
| | Steel | | | 8G*+ | | | 3-12 mm rust blisters |
| | | 2 | 10 | 7-8G*+ | 1.0-1.5 | 7.5 | 20 mm blister halo |
| | | | | | | | 3-10 mm rust blisters |
| 2 | Cold Rolled | 1 | 10 | 6S & | 0.5 | 9.0 | 20 mm blister halo |
| | Steel | | | 8G*+ | | | 2-8 mm rust blister |
| | | 2 | 10 | 6S & | 1.0 | 8.0 | 20 mm blister halo |
| | | | | 8G*+ | | | 3-8 mm rust blister |
| 3 | Cold Rolled | 1 | 10 | 7S & | 1.0-1.5 | 7.5 | 20 mm blister halo |
| | Steel | | | 7G*+ | | | 2-5 mm rust blister |
| | | 2 | 10 | 8G*+ | 1.0 | 8.0 | 20+ mm blister halo |
| | | | | | | | 2-10 mm rust blisters |
| 4 | Cold Rolled | 1 | 10 | 6S & | 1.0 | 8.0 | 15-20 mm blister halo |
| | Steel | | | 7G*+ | | | 5-8 mm rust blister |
| | | 2 | 10 | 7G*+ | 1.0-1.5 | 7.5 | 20 mm blister halo |
| | | | | | | | 2-7 mm rust blister |
| 5 | Cold Rolled | 1 | 10 | 7S & | 1.0 | 8.0 | 20 mm blister halo |
| | Steel | | | 8G*+ | | | 2-8 mm rust blister |
| | | 2 | 10 | 8G*+ | 1.0 | 8.0 | 15 mm blister halo |
| | | | | | | | 3-5 mm rust blister |
| 6 | Cold Rolled | 1 | 10 | 7-8G*+ | 1.0 | 8.0 | 15 mm blister halo |
| | Steel | | | | | | 1-10 mm rust blister |
| | | 2 | 10 | 7S & | 1.0 | 8.0 | 15-20 mm blister halo |
| | | | | 8G*+ | | | 2-8 mm rust blister |
| 7 | Cold Rolled | 1 | 10 | 5S & 5G | 1.0 | 8.0 | 5-35+ rust stains |
| | Steel | 2 | 10 | 5G & 7G | 0.5-1.0 | 8.0 | 5-20 mm rust blisters |

*Blisters around field corrosion sites,
+Film blistering around taped edges

TABLE 3
Test Results after 498 Hour Salt Spray Exposure - Scraped Scribes

| | | Panel | Coating Removed | Scribe | Scribe | | Spot Corrosion at |
|---|---|---|---|---|---|---|---|
| Sample | Substrate | No. | w/Scrape mm | Creep | Rating | % Area | Scribe |
| 1 | Cold Rolled | 1 | | | | | |
| | Steel | 2 | 10->32 | 1 | 8 | 90 | Up to 8 mm |
| 2 | Cold Rolled | 1 | | | | | |
| | Steel | 2 | 20->32 | 0-0.5 | 9 | 70 | Up to 8 mm |
| 3 | Cold Rolled | 1 | | | | | |
| | Steel | 2 | 20->32 | 0.5 | 9 | 75 | Up to 10 mm |
| 4 | Cold Rolled | 1 | | | | | |
| | Steel | 2 | 15->32 | 0-0.5 | 9 | 75 | Up to 7 mm |
| 5 | Cold Rolled | 1 | | | | | |
| | Steel | 2 | 20->32 | 0.5-1.0 | 8 | 95 | Up to 8 mm |
| | | | | | | | (13 one spot) |
| 6 | Cold Rolled | 1 | | | | | |
| | Steel | 2 | 15->32 | 1 | 8 | 100 | Up to 15 mm |
| 7 | Cold Rolled | 1 | | | | | |
| | Steel | 2 | 20->32 | 0-1.0 | 8 | 95 | Up to 20 mm |

At the end of testing all panels were allowed to dry then spray clear coated.

### Examples 4A Through 4E

Blends having a total weight of 800 grams of castor oil and Bisphenol-A alkoxylate (Syn Fac, a product of Milliken & Company) were charged into a 1-L, 4-neck reactor equipped with an overhead mixer, heating mantle, thermocouple probe, and nitrogen inlet. Mixing was set to ˜200 RPM with nitrogen flow set to ˜0.2 SCFH. The mixture was heated to 80° C. and kept at 80° C. for one hour. At this point, the blend was deemed complete and the mixture was poured out. Syn Fac 8027 is understood to be bisphenol A alkoxylated with 4 propylene oxide groups per molecule. Syn Fac 8385 is understood to be bisphenol A alkoxylated with 3 propylene oxide groups per molecule. The castor oil was obtained from Alnor Oil Company, and had a reported acid value of 2 mg KOH/g of sample max, an iodine value of 83-88, and a hydroxyl value of 160 to 168 mg KOH/g of sample. See Table 4A and Table 4B.

TABLE 4A
Table 4A: Castor Oil/Syn Fac Blend Properties¹

| | Example 4A | Example 4B | Example 4C | Example 4D | Example 4E |
|---|---|---|---|---|---|
| | 50/50 (Syn Fac | 50/50 (Syn Fac | 40/60 (Syn Fac | 60/40 (Syn Fac | 20/80 (Syn Fac |
| | 8385/Castor | 8027/Castor | 8027/Castor | 8027/Castor | 8027/Castor |
| | Oil Ratio by wt.) | Oil Ratio by wt.) | Oil Ratio by wt.) | Oil Ratio by wt.) | Oil Ratio by wt.) |
| Green Content | 50% | 50% | 40% | 60% | 80% |
| OHV | 230.8 | 208 | 221 | 200 | 192 |
| Viscosity @ 25 C. | 3,727 | 1,771 | 2,727 | 1,527 | 1,002 |
| Gel Time (min) | 52 | 74 | 74 | 62 | 44 |
| Shore D Hardness | 82 | 80 | 81 | 78 | 59 |
| Gardner Color | 1 | 1 | 1 | 2 | 2 |
| Dry Film Thickness | 7.4 | 6.36 | 5.6 | 6.32 | 5.2 |
| (average) | | | | | |
| Konig Sec. | 206 | 192 | 219 | 164 | 51 |
| Pencil Hardness | 8 | 8 | 8 | 7.5 | 3.5 |
| Adhesion | 5 | 5 | 5 | 5 | 4.5 |
| Mandrel ⅛″ | Pass | Pass | Pass | Pass | Pass |
| Mandrel ¼″ | Pass | Pass | Pass | Pass | Pass |
| MEK | >200 | >200 | >200 | >200 | >200 |
| Direct Impact | >160 | >160 | >160 | >160 | >160 |
| Indirect Impact | >160 | >160 | >160 | >160 | >160 |

¹Formulation: All above coatings were formulated using Rubinate M (Papi 27 equivalent) at a 1.05 NCO/OH, no catalyst was used and were baked to speed cure. The target dry film thickness (“DFT”) was between 5-7 mils for floor coatings.

TABLE 4B
Table 4B: Stain Test of Castor Oil/Syn Fac Blends

| | Example 4A | Example 4B | Example 4C | Example 4D | Example 4E |
|---|---|---|---|---|---|
| | 50/50 (Syn Fac | 50/50 (Syn Fac | 40/60 (Syn Fac | 60/40 (Syn Fac | 20/80 (Syn Fac |
| | 8385/Castor | 8027/Castor | 8027/Castor | 8027/Castor | 8027/Castor |
| Stain Test² | Oil Ratio by wt.) | Oil Ratio by wt.) | Oil Ratio by wt.) | Oil Ratio by wt.) | Oil Ratio by wt.) |
| Skydrol Resistance | 3 | 3 | 3 | 3 | 3 |
| Betadyne | 2 | 5 | 5 | 5 | 5 |
| 10% NaOH | 5 | 5 | 5 | 5 | 5 |
| 50% Sulfuric Acid | 5 | 5 | 5 | 5 | 5 |
| 20% Acetic Acid | 5 | 5 | 5 | 5 | 5 |
| Coffee | 5 | 5 | 5 | 5 | 5 |
| Tea | 5 | 5 | 5 | 5 | 5 |
| Mustard | 5 | 5 | 5 | 5 | 5 |
| Ketchup | 5 | 5 | 5 | 5 | 5 |
| Sharpie (Black | 3 | 4 | 4 | 4 | 4 |

²For the stain test the scale ranges from 5 down to 1:
5. No damage to coating or evidence of stain.
4. Coating shows very minor signs of damage, stain did not penetrate through to substrate.
3. Coating beginning to show some degradation, blistering, discoloration.
2. Coating is still intact but severely damaged, possibly completely delaminated but not dissolved.
1. Coating is completely destroyed/dissolved by the stain.

### Example 5

### Glycolysis: Step 1 and 2

A 4-neck, 2-L reactor equipped with an overhead mixer, condenser (set at 15° C.), heating mantle, thermocouple, and nitrogen inlet is charged with 378.17 g (25.42%) recycled polyethylene terephthalate (rPET), 159.03 g (10.69%) neopentyl glycol, 94.51 g (6.53%) propylene glycol, 17.80 g (1.20%) glycerol & 0.49 g (0.03%) monobutyltin oxide (MBTO). The reaction temperature is set at 200° C., nitrogen flow set to ˜0.2 SCFH with low (˜65 RPM) mixing. As the reactor contents homogenize (typically ˜140° C.) mixing is increased to ˜150 RPM. The mixture is held at 200° C. until no suspended pieces of rPET remain. If rPET is adhered to the side of the reactor, mixing is increased to wash in the rPET particles. Once all rPET particles are washed in and there is no visual evidence of rPET particles in solution, the glycolysis is complete. The trans-esterification is complete and the batch temperature is decreased to 180° C. for the 15 second glycolysis step. Once the batch temperature has stabilized at 180° C., 290.39 g (19.52%) recycled poly(bisphenol a carbonate) (rPBAC) is added via addition funnel and temperature is set at 200° C. Once the reactor contents reach 200° C., the glycolysis of rPBAC has begun. The batch is held at 200° C. for four hours to complete the second glycolysis step. Again, no visual evidence of rPBAC is deemed to indicate complete glycolysis.

### Esterification: Step 3

Once glycolysis is complete, the batch is cooled to <100° C. for the addition of isophthalic and succinic acid. Prior to the addition of the dicarboxylic acids the condenser is removed and replaced with a 5-stage separation column, above that a short path distillation head with overhead thermometer and collection flask. Via addition funnel 80.89 g (5.44%) isophthalic acid and 229.97 g (15.46%) succinic acid are added. The batch temperature is set at 150° C., mixing increased to ˜250 RPM as well as the nitrogen flow to ˜0.6 SCFH. The batch is now monitored by the overhead temperature above the short path distillation head. As the overhead temperature decreases below 90° C. the batch temperature is set 10° C. higher—from 150° C. to 160° C. to 170° C. to 180° C. to 190° C. to 200° C. Once the batch is at 200° C. the reaction contents are allowed to continue for four hours. Once the four-hour hold is complete, the batch temperature is set at 180° C. for overnight reaction. During the overnight reaction mixing is increased to ˜300 RPM and nitrogen is increased to ˜1.0 SCFH. Once the overnight reaction is complete, the polyester polyol is measured for acidity. If the acidity is <10 mg KOH/g but >5 mg KOH/g the polyol is deemed complete. If the acid value is >10 the batch is allowed to continue until the acid value is <10 and >5.

### Modification: Step 4

The now completed batch is cooled to 160° C. for the bisphenol a (BPA) modification step. Once the batch has stabilized at 160° C. 2.98 g (0.2 wt. %) sodium carbonate and 233.43 g (15.69 wt. %) propylene carbonate are added via addition funnel. The batch is then left at 160° C. for four hours and the progress of the BPA reduction is monitored by gel-permeation chromatography.

### Example 6

### Polyurethane Dispersions.

The polyol blends of the present invention are useful for making polyurethane dispersions. Using standard formulation and mixing procedures, aqueous polyurethane dispersions were prepared from the polyol blends of the present invention. The procedure involved the following steps for the dispersions shown in Table 5.
1. Charge the polyols, dimethylolpropionic acid (DMPA), Ymer™ N120, which is a product of Perstorp and described as a linear difunctional glycol monomethyl ether, N-methylpyrrolidinone (NMP), and catalyst (K-Kat 348, a product of King Industries) into a reaction vessel.
2. Heat to homogenize.
3. Add isocyanate, and monitor any exotherm.
4. Hold at 85° C. until target % NCO is achieved.
5. Increase mixing to approximately 1200 RPM, slowly add neutralizer diluted in water to 10% and defoamer.
6. Increase mixing to 1800 RPM, slowly add water to invert the prepolymer.
7. Add chain extender diluted to 10% in water.
8. Reduce mixing to 1200 RP and allow the dispersion to cool to 30-35° C.
9. Filter the resultant dispersion through a paint filter.

TABLE 5
Polyurethane Dispersion Synthesis/Components for a 30-40% By Weight Solids Dispersion

| | Polyurethane Dispersion | | | | | | | |
|---|---|---|---|---|---|---|---|---|
| | A | | B | | C | | D | |
| | Polyols | | | | | | | |
| | Example A | | Example B¹ | | Example 5C¹ | | Example 4D | |
| | 60/40 (Syn Fac | | 80/20 (Polyol | | 80/20 (Polyol | | 50/50 (Syn Fac | |
| | 8027/Castor Oil | | A/Syn Fac 8027 | | A/Syn Fac 8027 | | 8027/Castor | |
| | Ratio by wt.) | | Ratio by wt solids) | | Ratio by wt solids) | | Oil Ratio by wt.) | |
| Isocyanate, Isophorone | 15.83 | wt % | 11.09 | wt % | 11.08 | wt % | 15.5 | wt % |
| Diisocyanate | | | | | | | | |
| Neutralizer | Triethanolamine, | | Triethanolamine, | | 4-ethyl- | | Triethanolamine, | |
| | 1.63 wt % | | 1.75 | | morpholine, | | 1.67 | |
| | | | | | 1.28 | | | |
| Chain extender, | 1.41 | wt % | 0.99 | | 0.99 | | 1.38 | |
| Etheylene Diamine | | | | | | | | |
| Ymer N120 | 2.95 | wt % | 3.17 | | 3.17 | | 3.01 | |
| DMPA | 1.54 | wt % | 1.66 | | 1.66 | | 1.58 | |
| Bismuth Catalyst | 0.03 | wt % | 0.04 | | 0.04 | | 0.04 | |
| NMP | 1.71 | wt % | 1.85 | | 1.85 | | 1.75 | |
| Run Temperature | 85° | C. | 85° | C. | 85° | C. | 85° | C. |

¹Example B and C - Polyol A is a PET containing polyester polyol with OHV of 66, viscosity of 22,000 cP at 25 C. and density of 9.8 lb/gal.

### Example 7

### Floor Coatings.

The polyol blends of the present invention are useful for making floor coatings. Using standard formulation and mixing procedures, the following three floor coatings were made according to the following Tables 6A, 6B, and 6C, review using BiOH 5300/Syn Fac blends of the indicated compositions. The coatings were baked to speed cure, and the target thickness for the floor coatings was 5-7 mils.

Performance data for the three floor coatings is provided in Table 7.

TABLE 6A
Floor Coating Composition
BiOH 5300/Syn Fac 8027 (50/50)

| | | Target | Actual | | | MW | | NCO | |
|---|---|---|---|---|---|---|---|---|---|
| Component | Wt % | (g) | (g) | Fn | OHV | (g/mol) | Mol | Eqv. | OH Eqv. |
| BiOH 5300 | 34.53% | 20.00 | | 2.00 | 117.0 | 959.15 | 0.02 | | 0.042 |
| Syn Fac | 34.53% | 20.00 | | 2.00 | 238.0 | 471.51 | 0.04 | | 0.085 |
| 8027 | | | | | | | | | |
| Rubinate M | 30.93% | 17.92 | | 2.70 | | 340.00 | 0.05 | 0.133 | |
| (Papi 27) | | | | | | | | | |
| Total | 100.00% | 57.92 | 0 | | | Index | 1.0500 | Final | 0.006 |
| | | | | | | | | NCO Eqv. | |
| | | | | | | % NCO | 0.46% | Eqv. Wt | 9153.9 |
| | | | | | | | | (g/Eqv.) | |
| | | | | | | mmol | 6.1 | | |
| | | | | | | NCO | | | |

TABLE 6B
Floor Coating Composition
BIOH 5300/Syn Fac 8027 (40/60)

| | | Target | Actual | | | MW | | NCO | |
|---|---|---|---|---|---|---|---|---|---|
| Component | Wt % | (g) | (g) | Fn | OHV | (g/mol) | Mol | Eqv. | OH Eqv. |
| BioH 5300 | 27.06% | 16.00 | | 2.00 | 117.0 | 959.15 | 0.02 | | 0.033 |
| Syn Fac | 40.58% | 24.00 | | 2.00 | 238.0 | 471.51 | 0.05 | | 0.102 |
| 8027 | | | | | | | | | |
| Rubinate M | 32.36% | 19.14 | | 2.70 | | 340.00 | 0.06 | 0.142 | |
| (Papi 27) | | | | | | | | | |
| Total | 100.00% | 59.14 | 0 | | | Index | 1.0500 | Final | 0.007 |
| | | | | | | | | NCO | |
| | | | | | | | | Eqv. | |

TABLE 6C
Floor Coating Composition
BIOH 5300/Syn Fac 8027 (60/40)

| | | Target | Actual | | | MW | | NCO | |
|---|---|---|---|---|---|---|---|---|---|
| Component | Wt % | (g) | (g) | Fn | OHV | (g/mol) | Mol | Eqv. | OH Eqv. |
| BioH 5300 | 42.33% | 24.00 | | 2.00 | 117.0 | 959.15 | 0.03 | | 0.050 |
| Syn Fac | 28.22% | 16.00 | | 2.00 | 238.0 | 471.51 | 0.03 | | 0.068 |
| 8027 | | | | | | | | | |
| Rubinate M | 29.45% | 16.69 | | 2.70 | | 340.00 | 0.05 | 0.124 | |
| (Papi 27) | | | | | | | | | |
| Total | 100.00% | 56.69 | 0 | | | Index | 1.0500 | Final | 0.006 |
| | | | | | | | | NCO | |
| | | | | | | | | Eqv. | |

TABLE 7
Floor Coating Performance Data

| | Polyol | | |
|---|---|---|---|
| | BiOH 5300/ | BiOH 5300/ | BiOH 5300/ |
| | Syn Fac 8027 | Syn Fac 8027 | Syn Fac 8027 |
| | (50/50) From | (40/60) From | (60/40) From |
| | Table 6A | Table 6B | Table 6C |
| DTF Average | 8.37 | 8.17 | 7.45 |
| Konig Osc Average | 77 | 118 | 47 |
| Konig Sec Average | 107 | 163 | 65 |
| Pencil Average | HB | HB | B |
| Shore D Hardness | 79 | 83 | 72 |
| Adhesion Average | 5B | 5B | 5B |
| Mandrel ⅛″ | Pass | Pass | Pass |
| Mandrel ¼″ | Pass | Pass | Pass |
| Vinegar 1 h Spot | 5 | 5 | 5 |
| Vinegar 1 h Spot | 5 | 5 | 5 |
| 1 h Recovery | | | |
| Windex 1 h Spot | 5 | 5 | 5 |
| Windex 1 h Spot | 5 | 5 | 5 |
| 1 h Recovery | | | |
| 50% EtOH 1 h Spot | 5 | 5 | 5 |
| 50% EtOH 1 h Spot | 5 | 5 | 5 |
| 1 h Recovery | | | |
| Betadine 1 h Spot | 5 | 5 | 5 |
| Betadine 1 h Spot | 5 | 5 | 5 |
| 1 h Recovery | | | |
| Skydrol 1 h Spot | 3 | 3 | 3 |
| Skydrol 1 h Spot | 3 | 3 | 3 |
| 1 h Recovery | | | |
| MEK, damage | 60 | 68 | 43 |
| MEK, break | >200 | >200 | >200 |
| Direct Impact | 80 | 160 | 160 |
| Indirect Impact | 10 | <10 | 160 |

### INCORPORATION BY REFERENCE

The entire disclosure of each of the patent documents, including certificates of correction, patent application documents, scientific articles, governmental reports, websites, and other references referred to herein is incorporated by reference herein in its entirety for all purposes. In case of a conflict in terminology, the present specification controls.

### EQUIVALENTS

The invention can be embodied in other specific forms without departing from the spirit or essential characteristics thereof. The foregoing embodiments are to be considered in all respects illustrative rather than limiting on the invention described herein. In the various embodiments of the present invention, where the term “comprises” or “comprising” is used with respect to the components etc., it is also contemplated that the alternative “consists essentially of” or “consisting essentially of”, or “consists of” or “consisting of”, can as appropriate and upon the context be alternatively recited. Further, it should be understood that the order of steps or order for performing certain actions is immaterial so long as the invention remains operable. Moreover, two or more steps or actions can be conducted simultaneously.

In the specification, the singular forms also include the plural forms, unless the context clearly dictates otherwise. Unless defined otherwise, all technical and scientific terms used herein have the same meaning as commonly understood by one of ordinary skill in the art to which this invention belongs. In the case of conflict, the present specification will control.

Furthermore, it should be recognized that in certain instances a composition can be described as being composed of the components prior to mixing, because upon mixing certain components can further react or be transformed into additional materials.

All percentages and ratios used herein, unless otherwise indicated, are by weight.

What is claimed is:

1. A polyol blend comprising:
(a) a polyol selected from a polyester polyol, a polycaprolactone polyester polyol, a poly(hydroxyl alkyl carboxylic acid) polyester polyol, a polyether polyol, a polycarbonate polyol, a polyester/carbonate polyol, a polyether/ester polyol, an acrylic polyol, an oleochemical polyol, polyaspartic esters, and combinations thereof; and; and
(b) a polyphenol alkoxylate or a ring opened polyglycidyl ether,
wherein the polyol blend comprises greater than 10 wt % recycle content and a VOC content of less than about 250 g/l.

2. (canceled)

3. (canceled)

4. The polyol blend according to claim 1 wherein the polyether polyol comprises a poly(1,2-butylene oxide) polyol; a polyether polyol comprising copolymers of 1,2-butylene oxide with 1,2-propylene oxide, ethylene oxide or mixtures of 1,2-propylene oxide with ethylene oxide; or mixtures thereof.

5. The polyol blend according to claim 1 wherein the polyether polyol has a water solubility at 23° C. of less than 7.5% by weight.

6. (canceled)

7. (canceled)

8. The polyol blend according to claim 1 wherein the polyol is selected from a polyester polyol, a polytetrahydrofuran polyol, a poly-(1,3,-propanediol) polyol, a polyester/carbonate polyol, a polyether/ester polyol, an oleochemical polyol, a polycarbonate polyol and combinations thereof.

9. The polyol blend according to claim 1 wherein the polyphenol alkoxylate is selected from a bisphenol alkoxylate, a triphenol alkoxylate, and combinations thereof.

10.-22. (canceled)

23. The polyol blend according to claim 1 wherein the polyol blend has a viscosity less than about 15,000 cP at 25° C.

24.-44. (canceled)

45. A polyol blend comprising
(a) 10-90% by weight of an alkoxylated bisphenol A;
(b) 90-10% by weight of a polyol selected from castor oil, ethoxylated castor oil and mixtures thereof,
wherein the polyol blend comprises a VOC content of less than about 250 g/l.

46. A wood or concrete coating composition comprising the reaction product of:
(a) the polyol blend according to claim 45; and
(b) a crosslinker selected from a melamine crosslinker, a diisocyanate trimer, a diisocyanate, or a polyisocyanate.

47.-55. (canceled)

56. A metal coating composition comprising the reaction product of:
(a) a polyol blend according to claim 1, and
(b) a crosslinker selected from a melamine crosslinker, a diisocyanate trimer, a diisocyanate, or a polyisocyanate.

57. The metal coating composition according to claim 56 that is a direct-to-metal coating composition.

58. (canceled)

59. The direct-to-metal coating composition according to claim 57 wherein the coating is formulated at an NCO/OH ratio from 0.5 to 2.0.

60.-89. (canceled)

90. A polyol blend comprising:
(a) a polyol selected from a polyester polyol, a polyether polyol, a polycarbonate polyol, a polyester/carbonate polyol, a polyether/ester polyol, an acrylic polyol, an oleochemical polyol, and combinations thereof; and
(b) a tristyryl phenol alkoxylate.

91. The polyol blend according to claim 90 wherein the tristyryl phenol alkoxylate is a tristyryl phenol ethoxylate.

92. The polyol blend according to claim 91 wherein the tristyryl phenol alkoxylate is a tristyryl phenol ethoxylate having about 16 units of ethylene oxide.

93. (canceled)

94. A method for preparing a substantially isocyanate-free polyurethane comprising the steps of:
(a) reacting a polyol blend according to claim 1 with an alkyl carbamate or urea to form a polycarbamate, and
(b) reacting the polycarbamate from step (a) with a polyaldehyde or an acetal or hemiacetal thereof in the presence of a triggering agent to form the polyurethane.

95. The method according to claim 94 wherein the polyaldehyde is selected from cis-1,3-cyclohexanedicarboxaldehyde, trans-1,3-cyclohexanedicarboxyaldehyde, cis 1,4-cyclohexanedicarboxaldehyde, trans 1,4-cyclohexanedicarboxyaldehyde, acetals or hemiacetals thereof, and mixtures thereof.

96. The method according to claim 94 wherein the triggering agent is an acid with a pKa of less than 6.0 or a Lewis acid.

97. The method according to claim 94 wherein the alkyl carbamate is selected from methyl carbamate, ethyl carbamate, and mixtures thereof.

98. The method according to claim 97 wherein the alkyl carbamate is methyl carbamate.

99. A method for preparing a polyurethane comprising the steps of:
(a) reacting a polyol blend according to claim 1 with a di- or polyisocyanate to form a polymeric di- or polyisocyanate intermediate;
(b) reacting of the polymeric polyisocyanate intermediate from step (a) with a hydroxyalkyl carbamate to form a polycarbamate, and
(c) reacting the polycarbamate from step (b) with a polyaldehyde or an acetal or hemiacetal thereof in the presence of a triggering agent to form the polyurethane.

100. The method according to claim 99 wherein the di- or polyisocyanate is selected from hexamethylene diisocyanate, methylenebis(phenyl isocyanate) (MDI), polymeric methylene bis(phenyl isocyanate), toluene diisocyanate (TDI), hexamethylene diisocyanate (HDI), naphthalene diisocyanate (NDI), methylene bis-cyclohexylisocyanate (HMDI), isophorone diisocyanate (IPDI), xylylene diisocyanate, hydrogenated xylylene diisocyanate, 2,2,4-trimethyl hexamethylene diisocyanate, 2,4,4-trimethyl hexamethylene diisocyanate pentamethylene 1,5-diisocyanate, derivatives of the foregoing, and combinations thereof.

101. The method according to claim 99 wherein the hydroxyalkyl carbamate is hydroxyethyl carbamate.

102. The method according to claim 99 wherein the polyaldehyde is selected from cis-1,3-cyclohexanedicarboxaldehyde, trans-1,3-cyclohexanedicarboxyaldehyde, cis 1,4-cyclohexanedicarboxaldehyde, trans 1,4-cyclohexanedicarboxyaldehyde, acetals or hemiacetals thereof, and mixtures thereof.

103.-111. (canceled)
